(19) United States
(12) Patent Application Publication
(10) Pub. No.: US 2025/0356144 A1
(43) Pub. Date: Nov. 20, 2025

(54) TECHNIQUES FOR MULTILINGUAL CONTEXT DATA GENERATION AND ANNOTATION

(71) Applicant: Oracle International Corporation., Redwood Shores, CA (US)

(72) Inventors: Praneet Pabolu, Bangalore (IN); Karan Dua, Bijnor (IN); Ranjeet Kumar Gupta, Bengaluru (IN)

(73) Assignee: Oracle International Corporation, Redwood Shores, CA (US)

(21) Appl. No.: 19/292,019

(22) Filed: Aug. 6, 2025

Related U.S. Application Data
(60) Provisional application No. 63/697,876, filed on Sep. 23, 2024.

(51) Int. Cl. G06F 40/58

(52) U.S. Cl. CPC G06F 40/58

(57) ABSTRACT

A method for generating multilingual aspect-based sentiment annotations in different languages includes, by a computing system, receiving first content in a first language and performing an inference of the first content for presence of a plurality of aspects, including identifying aspects within the first content, annotating the first content in accordance with the identified aspects within the first content, and generating an annotated first content. The method further includes receiving second content in a second language, including a translation of the first content, performing the inference of the second content for presence of the aspects to generate an annotated second content and producing a training set in the second language from the annotated second content. The training set is suitable for use, in the second language, in refining the inference in classifying portions of the second content into one of a plurality of polarities associated with the plurality of aspects.

### CROSS-REFERENCES TO RELATED APPLICATIONS

This application is a non-provisional of and claims the benefit and priority under 35 U.S.C. 119(e) of U.S. Provisional Application No. 63/697,876, titled “TECHNIQUES FOR MULTILINGUAL ABSA DATA GENERATION AND ANNOTATION,” and filed on Sep. 23, 2024, which is incorporated herein by reference in its entirety for all purposes.

### BACKGROUND

In recent years, the field of natural language processing has experienced significant advancements, particularly in the development of large language models and multilingual sentence embedding models. These advancements have led to notable improvements in sentiment analysis, including finer-grained techniques such as aspect-based sentiment analysis (ABSA). ABSA enables the detection of sentiment directed toward specific aspects or entities within a sentence, offering a more nuanced understanding of opinion and intent in user-generated content, reviews, social media, and other text sources.

Despite these advances, the development of multilingual ABSA systems continues to face substantial challenges. High-quality ABSA training datasets are often language-specific and require extensive manual annotation. For most languages, obtaining such annotated datasets is costly, labor-intensive, and often impractical due to the scarcity of publicly available resources. Conventional methods for expanding ABSA capabilities to additional languages rely heavily on machine translation or cross-lingual transfer learning, which often introduce errors in aspect localization and sentiment consistency during the translation process.

Traditional approaches typically lack robust mechanisms for validating the quality of automatically generated multilingual annotations. Errors may arise when aspect terms are mistranslated, sentiment polarities are incorrectly inferred, or sentence alignments fail. These inconsistencies propagate through training pipelines and negatively impact the performance of downstream models. The absence of scalable, automated filtering techniques further compounds the problem, making it difficult to scale ABSA model development across multiple languages.

### BRIEF SUMMARY

Techniques described herein are directed to a multilingual aspect-based sentiment analysis (ABSA) data generation and filtering system that enables the scalable creation of high-quality training data across languages. In embodiments, rather than relying on costly manual annotation or unreliable machine translations, this approach leverages a generative instruction-tuned language model to create synthetic English sentences with labeled sentiments tied to specific aspects (e.g., “battery life” or “customer service”), and then translates those sentences into non-English equivalents. The system uses a combination of token-level word alignment and confidence-based sentiment scoring to validate both the structure and sentiment consistency of each translation. The system checks whether the key aspects are correctly preserved across languages and whether the predicted sentiment still holds, using both alignment models and agreement across multiple sentiment predictors. Using a unique data filtration process described herein, only the most trustworthy examples are kept, forming a refined, high-precision dataset that can be used to train robust sentiment models in multiple languages. Such a system may be implemented, for example, as a part of a software as a service or an infrastructure as a service (IaaS) model of cloud computing.

At least one embodiment is directed to a method for generating multilingual aspect-based sentiment annotations across content in different languages. In an embodiment, a method includes, by a computing system, receiving first content in a first language and performing an inference of the first content for presence of a plurality of aspects. In embodiments, performing the inference includes identifying one or more aspects within the first content, annotating the first content in accordance with the one or more identified aspects within the first content, and generating an annotated first content. In embodiments, the method further includes receiving, by the computing system, second content in a second language, wherein at least a portion of the second content includes a translation of the first content into the second language. In embodiments, the method further includes, by the computing system, performing the inference of the second content for presence of the plurality of aspects to generate an annotated second content and producing a training set in the second language from the annotated second content. The training set is suitable for use, in the second language, in refining the inference in classifying portions of the second content into one of a plurality of polarities associated with the plurality of aspects.

In certain embodiments, the process further includes filtering the annotated second content by comparing the annotated second content with the annotated first content, wherein producing the training set includes integrating the filtered annotated second content into the training set

In certain embodiments, filtering the annotated second content includes noting a first set of words used in a portion of the first content, noting a second set of words used in a corresponding portion of the second content, and if a first number of words in the first set of words do not correspond to a second number of words in the second set of words, then eliminating the corresponding portion of the second content from the training set.

In certain embodiments, filtering the annotated second content further includes noting a first set of aspects identified in a portion of the first content, noting a second set of aspects identified in a corresponding portion of the second content, and if the first set of aspects and the second set of aspects are not in agreement, then eliminating the corresponding portion of the second content from the training set.

In certain embodiments, filtering the annotated second content further includes noting a first set of words used in a portion of the first content, noting a second set of words used in a corresponding portion of the second content, generating an alignment score for the corresponding portion of the second content in accordance with alignment of the second set of words with the first set of words, comparing the alignment score with a threshold alignment score, and if the alignment score is below the threshold alignment score, eliminating the corresponding portion of the second content from the training set.

In certain embodiments, the threshold alignment score is determined based on at least one of a manually configured parameter and a statistical analysis of alignment scores observed across different languages. In embodiments, generating the alignment score includes using a dot product operation between embedded tokens in the portion of the first content and the portion of the second content.

In certain embodiments, performing the inference includes using an inference model pre-trained on a gold data set including known annotated data in the first language. In embodiments, filtering the annotated second content includes comparing a first number of aspects identified in a portion of the first content with a second number of aspects identified in a corresponding portion of the second content, and if the first number of aspects is not equal to the second number of aspects, then eliminating the corresponding portion of the second content from the training set.

In certain embodiments, the first content is generated using a generative large language model (LLM). In embodiments, the second content is generated by a machine translation of the first content. In certain embodiments, the method further includes finetuning instructions provided to the large language model to produce the first content.

In certain embodiments, the method further includes extracting a portion of the first content, substituting words within the portion of the first content to flip sentiments associated with the plurality of polarities, adding the portion of the first content, including the substituted words, into the first content to produce a modified first content, translating the modified first content to produce a modified second content, and repeating performing the inference, filtering, and producing the training set for the modified first content and the modified second content.

In certain embodiments, the method further includes extracting a portion of the first content, modifying words in the portion, other than the one or more aspects, by changing at least one of morphology, tense, pronoun, and phrasing, adding the portion of the first content, including the substituted words, into the first content to produce a modified first content, translating the modified first content to produce a modified second content, and repeating performing the inference, filtering, and producing the training set for the modified first content and the modified second content. In embodiments, modifying words in the portion includes substituting at least one of the words in the portion with one of a synonym and an antonym.

In certain embodiments, the method further includes extracting a portion of the training set, modifying at least one of the plurality of polarities in the extracted portion, and adding the modified portion into the training set to produce a modified training set.

In embodiments, a computing system includes one or more data processors and a storage medium configured to store instructions that, when executed on the one or more processors, cause the one or more data processors to perform operations including receiving, by the computing system, first content in a first language and performing, by the computing system, an inference of the first content for presence of a plurality of aspects. In certain embodiments, performing the inference includes identifying one or more aspects within the first content, annotating the first content in accordance with the identified one or more aspects; and generating an annotated first content, and receiving, by the computing system, second content in a second language, wherein at least a portion of the second content includes a translation of the first content into the second language. In certain embodiments, the operations further include performing, by the computing system, the inference of the second content for presence of the plurality of aspects to generate an annotated second content, and producing, by the computing system, a training set in the second language from the annotated second content. The training set is suitable for use, in the second language, in refining the inference in classifying portions of the second content into one of a plurality of polarities associated with the plurality of aspects.

In certain embodiments, the operations further include filtering, by the computing system, the annotated second content by comparing the annotated second content with the annotated first content. Producing the training set may include integrating the filtered annotated second content into the training set. In certain embodiments, filtering the annotated second content includes comparing a first number of aspects identified in a portion of the first content with a second number of aspects identified in a corresponding portion of the second content. If the first number of aspects is not equal to the second number of aspects, then the operations include eliminating the corresponding portion of the second content from the training set.

In embodiments, a non-transitory computer-readable medium storing a plurality of instructions executable by one or more processors of a computing system is disclosed. The plurality of instructions cause, when executed by the one or more processors of the computing system, the one or more processors to perform operations including receiving, by the computing system, first content in a first language and performing, by the computing system, an inference of the first content for presence of a plurality of aspects. In embodiments, performing the inference includes identifying one or more aspects within the first content, annotating the first content in accordance with the identified one or more aspects, and generating an annotated first content. In certain embodiments, the operations further include receiving, by the computing system, second content in a second language, wherein at least a portion of the second content includes a translation of the first content into the second language. In embodiments, the operations further includes performing, by the computing system, the inference of the second content for presence of the plurality of aspects to generate an annotated second content and producing, by the computing system, a training set in the second language from the annotated second content, wherein the training set is suitable for use, in the second language, in refining the inference in classifying portions of the second content into one of a plurality of polarities associated with the plurality of aspects.

### BRIEF DESCRIPTION OF THE DRAWINGS

FIG. 1 is an example of an environment that utilizes an aspect-based sentiment analysis (ABSA)-enabling system for providing services of performing sentiment analysis for text provided a first language, in which the ABSA system has been trained.

FIG. 2 is a flowchart illustrating a training process for training an ABSA system in analyzing text input for a first language, such as shown in FIG. 1.

FIG. 3 is a simplified diagram of an environment that utilizes ABSA system trained in a second language for providing services of performing sentiment analysis for a second language, in which the ABSA system has been trained, according to certain embodiments.

FIG. 4 is a flowchart illustrating a training process for training an ABSA system in analyzing text input in a second language to produce an ABSA system trained in the second language, such as shown in FIG. 3.

FIG. 5 is a flowchart illustrating an alternative training process for training an ABSA system in analyzing text input in a second language to produce an ABSA system trained in the second language, such as shown in FIG. 3.

FIG. 6 is a flowchart illustrating an exemplary process for generating annotated content in a second language, suitable for use in training an ABSA system in a second language, in accordance with embodiments.

FIG. 7 is a flowchart illustrating another exemplary process for generating annotated content in a second language, suitable for use in training an ABSA system in a second language, in accordance with embodiments.

FIG. 8 is a flowchart illustrating still another exemplary process for generating annotated content in a second language, suitable for use in training an ABSA system in a second language, in accordance with embodiments.

FIG. 9 is a simplified diagram illustrating an ABSA training set generation system, in accordance with embodiments.

FIG. 10 is a simplified diagram illustrating an example of a word alignment module of the data filtration subsystem in FIG. 9, according to certain embodiments.

FIG. 11 is an example flowchart illustrating processing performed by the data filtration subsystem, according to certain embodiments.

FIG. 12 is a block diagram illustrating one pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating an example computer system, according to at least one embodiment.

### DETAILED DESCRIPTION

Aspect-based sentiment analysis (ABSA) is an analysis approach for assessing sentiment expressed in text towards specific aspects. Such analysis is useful, for example, in automatically assessing sentiments expressed in customer surveys and comments collected as related to a specific service or product. In particular, unlike traditional sentiment analysis, in which an overall sentiment label is assigned to a block of text, ABSA is a branch of Sentiment Analysis that deals at a much granular level of text by analyzing individual aspects in the text and classifying them into, for example, one of four polarities (positive, negative, neutral and mixed).

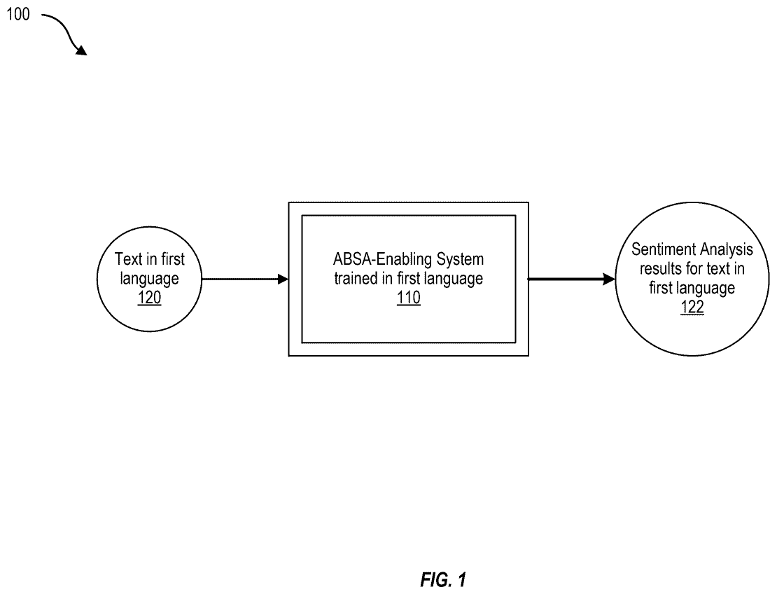

FIG. 1 is an example of an environment 100 that utilizes an aspect-based sentiment analysis (ABSA)-enabling system to perform sentiment analysis. As shown in FIG. 1, environment 100 includes an ABSA system 110 including machine learning (ML) models performing aspect-based sentiment analysis. An aspect may include, for example, words related to a specific feature, attribute, or component of a product, service, or topic being discussed or evaluated in the text. One or more aspects identified within a text may be used to classify the text as being associated with one of the predefined polarities associated with sentiment expressed toward a particular aspect, such as positive, negative, neutral, and mixed.

The ML models in ABSA system 110 has been trained for performing sentiment analysis in a first language such that, when text in the first language 120 is fed into ABSA system 110, the output is sentiment analysis results 122 in the first language. For instance, the input data to the ABSA system may include English text with one or more aspect annotations. The input data may be divided or duplicated into four sentiment polarity groups, where each sentiment polarity group may be provided to a trained sentiment analysis model within the ABSA system. In embodiments, four sentiment analysis models may be running in parallel and independently to process their respective input groups. In examples, each sentiment analysis model may be specifically trained to predict a particular sentiment polarity, such as positive, negative, neutral, and mixed. The output of the four parallel-running sentiment models may generate the predicted or annotated aspect sentiments for English text.

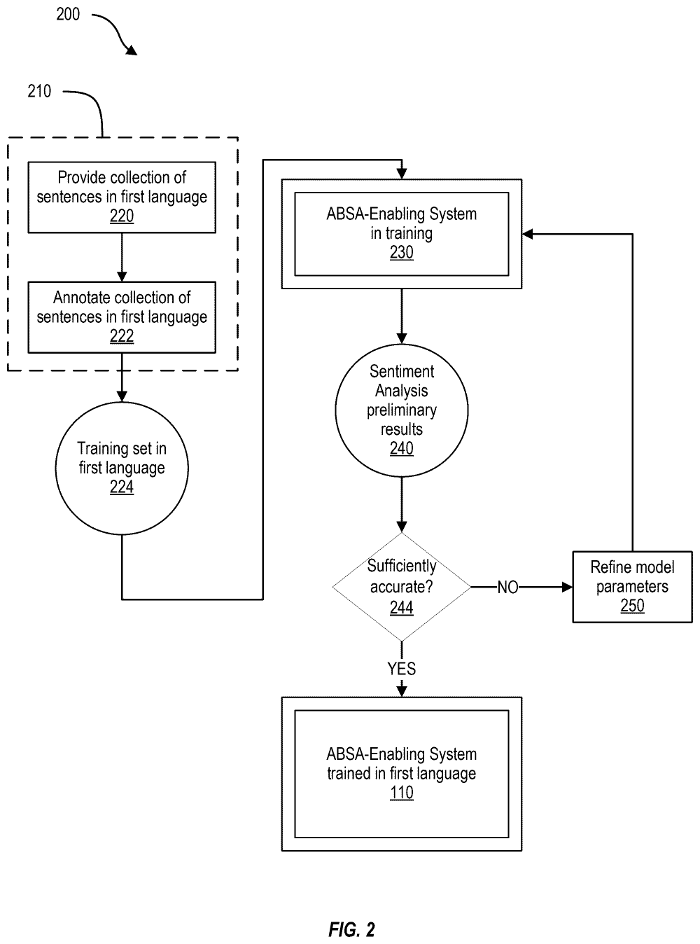

FIG. 2 shows an exemplary flowchart for training an ABSA system in a first language. In the example illustrated in FIG. 2, a process 200 includes a section 210 for generating a training set suitable for use in training the ML models used in performing the ABSA. Section 210 includes, in the illustrated example, a step 220 to provide a collection of sentences in the first language. This collection of sentences may include, for example, a portion of an archive of previously collected data, manually generated sentences, machine generated data using a trained large language model, or a combination thereof.

The collection of sentences is annotated in 222 to identify aspects for use in the ABSA processing. The annotated sentences become the basis for a training set 224 in the first language. This training set 224 is then fed into an ABSA system in training 230, which produces sentiment analysis preliminary results 240. The preliminary results are assessed at a decision 244 to make a determination whether the preliminary results are sufficiently accurate. The determination may be made, for example, in comparison with a set of “gold” data, which has been previously assessed for accuracy. If the results of decision 244 is NO, the results are not yet sufficiently accurate, then process 200 proceeds to refine the model parameters in 250, which are used to adjust ABSA system in training 230 to again produce preliminary results for further assessment. If the results of decision 244 is YES, the results are sufficiently accurate, then the ABSA system in training is adapted as the ABSA system trained in the first language, such as ABSA system 110 of FIG. 1.

A shortcoming of the ABSA approach is that the assessment tends to be specific to the language in which the ABSA system has been trained. For example, an ABSA system trained in the English language will produce inaccurate results if text in a non-English language is used as input.

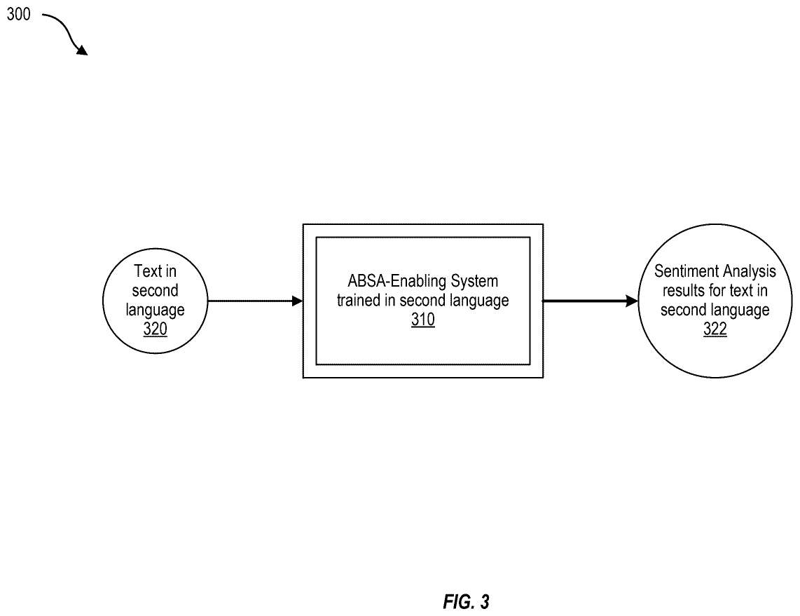

FIG. 3 is an example of an environment that utilizes an aspect-based sentiment analysis (ABSA)-enabling system, now trained in a second language, to perform sentiment analysis. As shown in FIG. 3, an environment 300 includes an ABSA system 310 including ML models that have been trained for performing sentiment analysis in the second language such that, when text in the second language 320 is fed into ABSA system 310, the output is sentiment analysis results 322 in the second language. As noted above, if text in the first language is fed into ABSA system 310, or if text in the second language is fed into ABSA system 110 of FIG. 1, the resulting sentiment analysis results in either case will likely be highly inaccurate.

Existing approaches to training ABSA models in multiple languages face critical limitations. While modern large language models and embedding architectures have significantly advanced sentiment understanding in high-resource languages like English, performance in other languages remains inconsistent and constrained by the lack of reliable training data. Whereas a large corpus of sample, annotated text may be available for a specific language (e.g., English and/or Spanish), training sets in other languages may not be readily available.

One particular point of difficulty in expanding the ABSA system to multiple languages is the requirement for language-specific training sets with annotations to identify specific aspects for use in classification of the text into different sentiments or polarities. Traditionally, ABSA training data must be manually labeled for each target language, a process that is both time-consuming and costly.

As a workaround, some systems attempt to translate English-labeled data into other languages; however, such methods often introduce translation inconsistencies, lose aspect granularity, or misrepresent sentiment polarity. These issues degrade the quality of the training corpus and ultimately reduce the accuracy and robustness of multilingual ABSA models.

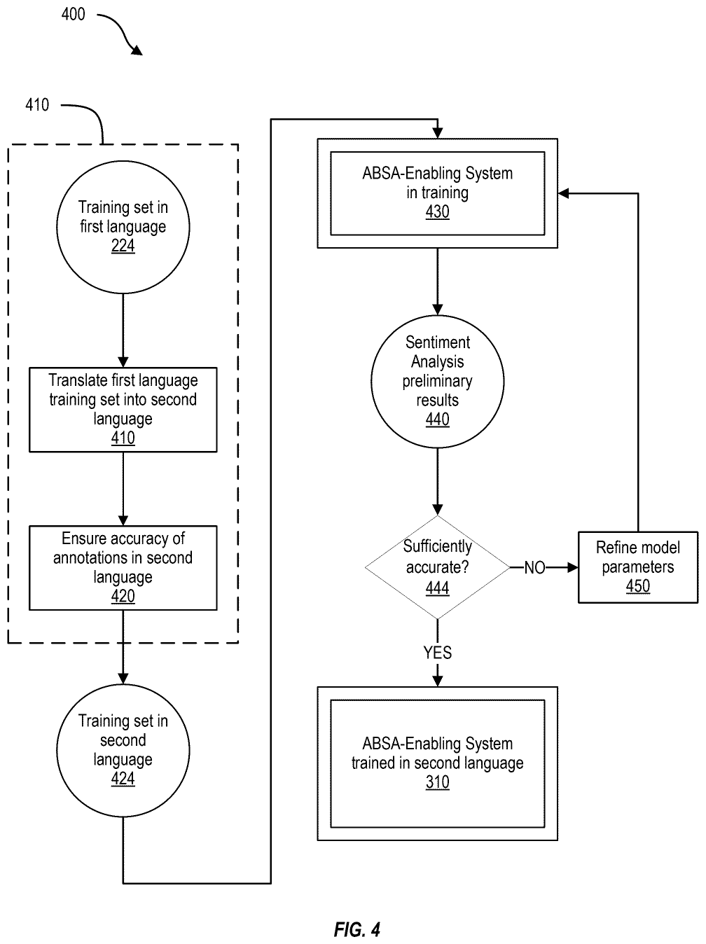

FIG. 4 shows an exemplary flowchart for training an ABSA system in a second language using this translation approach. In the example illustrated in FIG. 4, a process 400 includes a section 410 for generating a training set suitable for use in training the ML models used in performing the ABSA in the second language. As shown in FIG. 4, section 410 begins with a training set in the first language, such as training set 224 of FIG. 2, which already includes annotations in the first language. Section 410 further includes a step 410 to translate the training set in the first language into the second language, then a step 420 to ensure accuracy of annotations in the second language. Step 420 may be performed manually or by machine using, for example, a trained classification or annotation model in the second language. As discussed above, while a crucial step for ensuring accuracy of the trained ABSA system step 420 is often costly in terms of time and resources required to perform well.

The collection of translated and annotated sentences become the basis for a training set 424 in the second language. Like in the process illustrated in FIG. 2, this training set 424 is fed into an ABSA system in training 430 to produce sentiment analysis preliminary results 440. The preliminary results are assessed at a decision 444 to make a determination whether the preliminary results are sufficiently accurate, based for example on a comparison with a set of gold data. If the results of decision 444 is NO, the results are not yet sufficiently accurate, then process 400 proceeds to refine the model parameters in 450 to adjust ABSA system in training 430, and the preliminary result production and assessment are repeated. If the results of decision 444 is YES, the results are sufficiently accurate, then the ABSA system in training is adapted as the ABSA system trained in the second language, such as ABSA system 310 of FIG. 3.

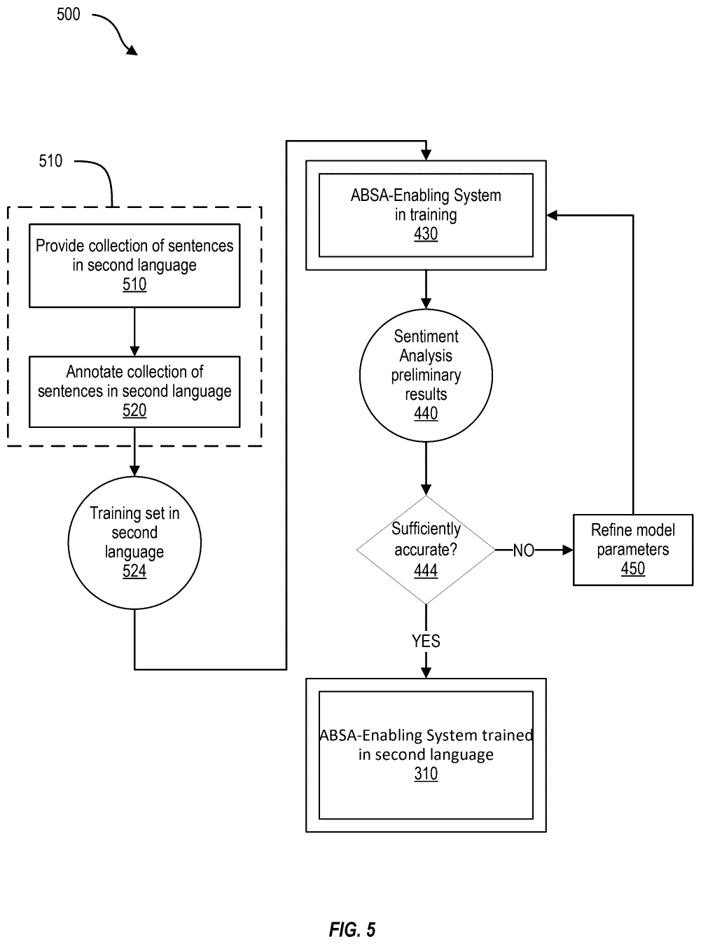

Another approach to generating a training set in a second language is shown in FIG. 5, which essentially replicates in the second language the operations from FIG. 2 for the first language. A process 500 includes a section 510, which includes a step 510 to provide a collection of sentences in the second language, in a manner similar to step 210 of FIG. 2. Again, this collection of sentences may include, for example, a portion of an archive of previously collected data, manually generated sentences, machine generated data using a trained large language model, or a combination thereof. The collection of sentences in step 510 is annotated in 520 to identify aspects for use in the ABSA processing, and the annotated sentences become the basis for a training set 524 in the second language. The remainder of process 500 follows a similar series of steps as illustrated in FIG. 4 to produce ABSA system 310 trained in the second language.

Generating training data with annotation for training ABSA models in a plurality of languages may involve classifying the aspects each language of interest. With increasing interest in localizing automated services used in training ABSA models across hundreds of languages, efficient generation of training sets localized to specific languages is highly desirable. It is recognized herein that a variety of publicly available sources offer parallel corpus of English or Spanish language text that have been translated, manually or by machine, into a variety of other languages, although such corpus of available texts are not annotated in a manner suitable for sentiment analysis as compatible with current ABSA systems. It is also recognized herein that, while existing training data for sentiment analysis may be manually or machine translated in bulk, such as illustrated in FIG. 4, accuracy of annotation in the translated text may not be sufficient, thus leading to inaccurate results produced by the ABSA systems trained on such translated data. Further, generation of such training data in a large number of languages is very expensive and time-consuming. Thus, there is a need to address these challenges and others. Embodiments described herein address these and other problems, individually and collectively.

The complications related to generating training sets in multiple languages for ABSA processing may be illustrated by an example of a first language (English) text input, the related annotations, and the parallel text in a second language (Arabic and Turkish) is shown in Table 1 below.

TABLE 1

| | 1 | 2 | |
|---|---|---|---|
| | English Text (e.g., | English Annotations | |
| | content to be | (identifying aspects in | 3 |
| | analyzed) | sentences) | Parallel Text |
| 1 | I have been blown | Conference: I have been | Arabic: [symbol] |
| | away by this | blown away by this | [symbol] |
| | conference, and I want | conference. | [symbol] |
| | to thank all of you for | Comments: I want to thank | [symbol] [symbol] |
| | the many nice | all of you for the many | [symbol] |
| | comments about what | nice comments about what I | |
| | I had to say the other | had to say the other | |
| | night. | night. | |
| 2 | Building a cheese | Cheese: Building a cheese | Turkish: Ekvator'da |
| | factory in Ecuador was | factory in Ecuador was a | peynir fabrikas1 yapmak |
| | a risk. | risk. | bir riskti. |
| | | Factory: Building a cheese | |
| | | factory in Ecuador was a | |
| | | risk. | |

As shown in Table 1, the left column includes the English text. The middle column includes the corresponding aspect annotations of the English text, which may be organized in a particular format recognized by a given ABSA system. For example, in the first English text (row 1), two aspects (e.g., conference and comments) have been identified as aspects. Similarly, in the second English text (row 2), two aspects (e.g., cheese and factory) have been identified.

The parallel text in a non-English language, corresponding to the original English text in column 1, is shown in the right column. In the example in Table 1, row 1, right column is an Arabic translation of the English text in row 1, left column. The row 2, right column, shows a Turkish translation of the second English text in row 2, left column.

While translating the first language text in the left column into the parallel text in a second language in the right column may be a relatively simple task by manual or machine translation, annotation of the parallel text in the second language is a challenge. For example, in certain types of ABSA processing, the input text and the annotations in the first language text are classified into four polarities, in accordance with the annotations corresponding to the identified aspects. For instance, the two aspects (i.e., conference and comments) identified in the English text of row 1 may be classified to belong to a positive sentiment group, and the two aspects (i.e., cheese and factory) of the English text in row 2 may classified as belonging to a negative sentiment group.

Table 2 below show the original English text, annotations with aspect sentiment as classified by the ABSA system processing, the parallel text in the second languages, and predicted annotations with aspect sentiment, again as classified by the ABSA system processing. As shown in Table 2, a challenge is ensuring the accuracy of the annotations and predicted aspect sentiment in the second language.

TABLE 2

| | | 2 | | 4 |
|---|---|---|---|---|
| | | English | | Predicted |
| | 1 | Annotations with | 3 | Annotations with |
| | English Text | aspect sentiment | Parallel Text | aspect sentiment |
| 1 | I have been blown | [{′entity′: ′B- | Arabic: [symbol] | [{′entity′: ′B- |
| | away by this | POSITIVE′, | [symbol] | POSITIVE′, ′word′: |
| | conference, and I | ′word′: | [symbol] | [symbol] {′entity′: ′B- |
| | want to thank all of | ′conference′}, | [symbol] | POSITIVE′, ′word′: |
| | you for the many | {′entity′: ′B- | | [symbol] ] |
| | nice comments | POSITIVE′, | | |
| | about what I had to | ′word′: | | |
| | say the other night. | ′comments′}] | | |
| 2 | Building a cheese | [{′entity′: ′B- | Turkish: Ekvator′da | [{′entity′: ′B- |
| | factory in Ecuador | NEGATIVE′, | peynir fabrikas1 yapmak | NEGATIVE′, |
| | was a risk. | ′word′: | bir riskti. | ′word′: |
| | | ′cheese′}, | | ′peynir′}, |
| | | {′entity′: ′I- | | {′entity′: ′I- |
| | | NEGATIVE′, | | NEGATIVE′, |
| | | ′word′: | | ′word′: |
| | | ′factory′}] | | ′fabrikas1′}] |

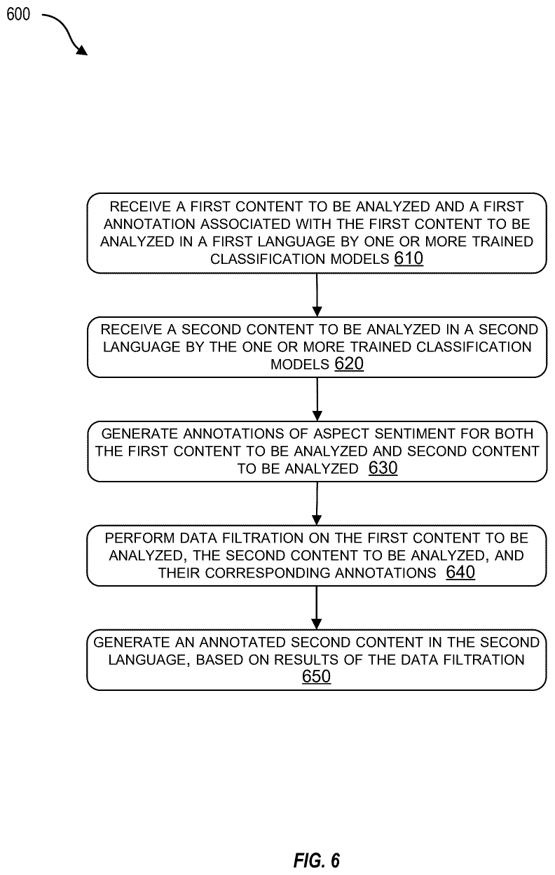

FIG. 6 illustrates an alternative approach to efficient generation of training sets for use in training ABSA systems in a plurality of languages. As shown in FIG. 6, a process 600 begins with receiving a first content (e.g., English text in the first column of Table 1) to be analyzed and a first annotation of aspects (e.g., second column of Table 1) associated with the first content to be analyzed in a first language (e.g., English) in 610. The analysis of the received content may be performed, for example, using a trained classification model, such as a Language-agnostic bidirectional encoder representations from transformers (BERT) Sentence Embedding (LaBSE) model (see, for example, Feng, et al., “Language-agnostic BERT Sentence Embedding,” 2007).

A suitable LaBSE model for ABSA systems may include a BERT-based model for multilingual sentence embedding and can encode text into high-dimensional vectors, which are trained and optimized to produce similar representations for bilingual sentence pairs that are translations of each other. For instance, a sentiment model can be configured to receive two parallel inputs, a source text and a target text (e.g., a translation of the source text), simultaneously. As the source text and the target text are closer to each other in a high-dimensional space after encoding, the sentiment model can be used to annotate the source text and then scale it to the target text with automatic annotations.

In an example, the LaBSE model used in step 610 may have been specifically trained for the English language to identify and annotate aspects in the first content, then classifying the first content into one of four sentiment polarities, in accordance with the aspects so identified. In certain embodiments, the LabSE model used in step 610 may include four separate machine learning models, each trained for one of the four sentiment polarities, such that the four separate machine learning models are operated in parallel to process the first content. For instance, each of the sentiment models may be fine-tuned to identify aspects in a received sentence and determine the corresponding sentiments of these aspects in a particular polarity as a single-step process. As an example, a first sentiment model (a positive sentiment model) may be fined-tuned to specialize in positive sentiment annotation. A second sentiment model (a negative sentiment model) may be fined-tuned to specialize in negative sentiment annotation. A third sentiment model (a neutral sentiment model) may be fined-tuned to specialize in neutral sentiment annotation. A fourth sentiment model (a mixed sentiment model) may be fined-tuned to specialize in mixed sentiment annotation. In certain embodiments, without the fine-tuning, a sentiment model may perform identifying aspects and determining sentiments as two separate processes.

At step 620, a second content to be analyzed in a second language (e.g., Arabic and Turkish texts in Column 3 of Table 1) is received and processed by the one or more trained sentiment models.

At step 630, annotations of aspect sentiment for both the first content to be analyzed and the second content to be analyzed are generated. It is recognized herein that the one or more trained sentiment models may have been trained in the first language (e.g., English) only, thus the annotated output, particularly in the second language, may include inaccuracies. Step 630 may include configuring the output such that the annotations are produced in the first and second languages, respectively, for the parallel texts.

In order to handle the potential inaccuracies introduced by processing the second content with the ABSA system trained in the first language, data filtration is performed on the first content to be analyzed, the second content to be analyzed, and their corresponding aspect-sentiment annotations in a step 640. In some embodiments, the filtration may include three sub-steps: (1) word alignment between English and non-English texts, (2) voting filtering for English aspect-sentiment annotation, and (3) aggregation, to be discussed in further detail below. Data filtering may result in the elimination of data deemed to be inaccurate. Finally, in a step 650, the result of the data filtration is used to generate an annotated second content in the second language. The annotated second content, due to the data filtration, should include annotated text in the second language with a high degree of translation and annotation accuracy.

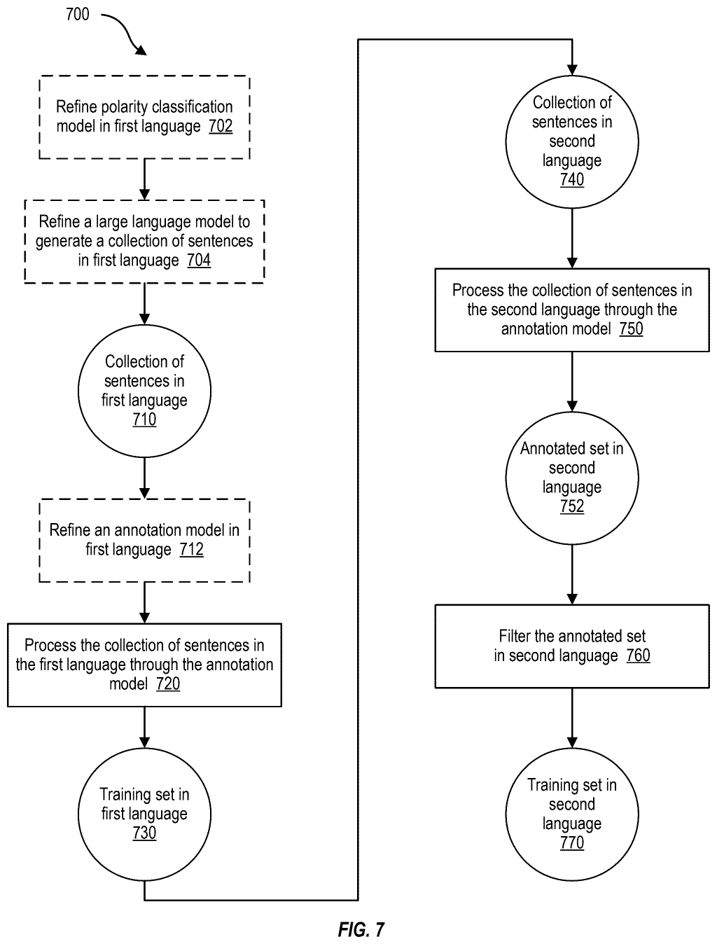

FIG. 7 illustrates a generalized process flow for efficiently generating a training set in a second language, where the training set is suitable for training an ABSA system in the second language. In embodiments, an objective of a process 700 is to generate high quality, synthetic ABSA training set with accurate annotations for use in polarity classification in one or more target languages. As shown in FIG. 7, process 700 may include an optional step 702 to refine a polarity classification model in a first language, such as discussed above with respect to the example of finetuning of four models for the four polarities. Process 700 may also include an optional step 704 to refine a large language model to generate a collection of sentences in the first language, if such automated generation of a corpus of text in the first language using a generative large language model (e.g., MosaicML Pretrained Transformer (MPT) and others) may be desired.

Process 700 starts with a collection of sentences in the first language (i.e., the first content as discussed with respect to FIG. 6 above). The sentences in the first language may be, for example, an archive of previously collected data (e.g., input from a customer comments section of a website, product reviews, and other similar text), manually generated sentences specifically for ABSA model training, publicly available collection of text, synthetic data generated using a trained large language model, etc. [0001] Optionally, process 700 includes a step 712 to refine an annotation model (e.g., LaBSE) in the first language. Alternatively, the annotation model may have previously been trained in the first language.

Process 700 proceeds to a step 720 to process the collection of sentences in the first language through the annotation model to generate a training set 730 in the first language, including annotations suitable for use in polarity classification in ABSA processing.

Then, process 700 proceeds to receiving a collection of sentences in a second language 740. The collection of sentences in the second language may be, for example, a manual or machine translation of the collection of sentences in the first language or obtained from a known parallel corpus corresponding to the collection of sentences in the first language, etc.

Process 700 proceeds to processing the collection of sentences in the second language through the annotation model. In embodiments, the annotation model used in step 750 is the same model used in step 720, so as to eliminate the necessity to train a second annotation model in the second language. In certain embodiments, a language-agnostic model, such as LaBSE may be used in both steps 720 and 750. As a result, an annotated set in the second language 752 is generated.

As discussed above, a step 760 to filter the annotated set in the second language helps to improve the accuracy of the translation and translation in a training set in the second language 770, generated as the final output of process 700.

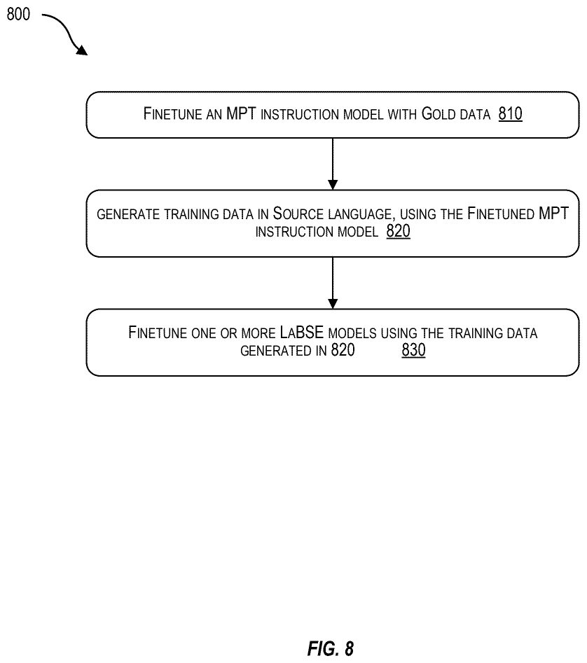

Further details of an exemplary embodiment to generate the collection of sentences in the first language (e.g., collection of sentences 710 of FIG. 7) using optional steps 702 and 704 of FIG. 7 are illustrated in FIG. 8. As shown in FIG. 8, a generalized method 800 for generating training data and training a sentiment analysis model includes finetuning a generative large language model (e.g., MPT instruction model, such as an MPT-7B-Instruct model for natural language processing configured to follow short-form instructions for generating output). The finetuning may include providing instructions in the first language (i.e., source language) with an established corpus of gold data with known annotations to define instructions for fine-tuning (e.g., using contextual prompting) the MPT instruction model. In some embodiments, the MPT instruction model may be trained using a MPT training suite in the first language.

Table 3 below illustrates exemplary input instructions for fine-tuning the MPT instruction model, and the corresponding output of the MPT model, suitable for use in step 810 of FIG. 8. As shown in Table 4, exemplary input instructions may include three parts. The first part may outline the polarities (e.g., positive, negative, neutral and mixed); The second part may link polarity to aspects in instructions. The third part may be a command, such as language to be generated and a number of sentences.

TABLE 3

| Input Instruction | Target Text (output of a MPT model) |
|---|---|
| With 4 polarities (Positive, | text: I enjoy ATT internet. It is reliable and I love the |
| Negative, Neutral and Mixed), | my smart home app. I love that you can test |
| come up with a creative text | the connection in every room with your camera . It's |
| that contains the below | so innovative. ATT is reasonable compared to other |
| mentioned aspects without | providers. I love that I did not need a technician to |
| changing their respective | connect my services. Other companies like to charge |
| polarity. | an extra fee. The only thing is you have to rent the |
| Positive Polarity aspects: ″ATT | router. The price for services is reasonable and my bill |
| internet, smart home app, | is always the same. I love that once the promotion is |
| connection, camera, ATT | over you can call and renegotiate. ATT connection is |
| connection, ATT, price″ | reliable. No worries here. |
| Now, generate a paragraph | According to the text generated above, the input |
| in English language having 12 | aspects can be found in the following sentences as |
| sentences, that contains these | mentioned below: |
| aspects in any order. | ATT internet: I enjoy ATT internet. |
| | smart home app: It is reliable and I love the |
| | my smart home app. |
| | connection: I love that you can test the connection in |
| | every room with your camera. |
| | camera: I love that you can test the connection in |
| | every room with your camera. |
| | ATT: ATT is reasonable compared to other |
| | providers. |
| | price: The price for services is reasonable and my bill |
| | is always the same. |
| | ATT connection: ATT connection is reliable. |

Table 4, shown below, illustrates an example of the training data generated using the finetuned MPT instruction model in 810.

TABLE 4

| | Target Text (i.e., LaBSE training data to fine- |
|---|---|
| Input Instruction | tune LaBSE) |
| Below is an instruction that describes a | text: These are a great price. I was surprised |
| task. Write a response that appropriately | because they were so cheap. They fit ok in my |
| completes the request. | size 11 shoes. I have been looking for socks to |
| ### Instruction: | wear with sandals that don't show my feet and |
| With 4 polarities (Positive, Negative, | these are ok but not quite right. |
| Neutral and Mixed), come up with a | According to the text generated above, the input |
| creative text that contains the below | aspects can be found in the following sentences as |
| mentioned aspects without changing their | mentioned below: |
| respective polarity. | price: These are a great price. |
| Positive Polarity aspects: “price” | fit: They fit ok in my size 11 shoes. |
| Neutral Polarity aspects: “fit” | socks: I have been looking for socks to wear with |
| Mixed Polarity aspects: “socks” | sandals that don't show my feet and these are ok |
| Now, generate a paragraph in English | but not quite right. |
| language having 4 sentences, that contains | |
| these aspects in any order. | |

At step 820, training data in the source language is generated, using the generative LLM (e.g., MPT instruction model) finetuned in 810. As, the generative LLM has been finetuned with gold data, with known accurate annotations, the training data in the source language as generate in step 820 exhibits a high degree of accuracy in the annotation. In a step 830, the one or more aspect classification models (e.g., LaBSE model) used in annotating the input text is finetuned using the training data generated in step 820.

For example, as shown in Table 5 above, the input instructions may include polarities for different aspects, such as “price” with positive polarity, and “fit” with neutral polarity. The trained MPT instruction model from step 810 may be used to generate training data containing the generated text, identified aspects, and annotations listing each aspect and its corresponding sentence in the output text. The target text in the right column can then be used as training data for fine-tuning the aspect classification models in step 830. Process 800 may then proceed to, for example, step 720 of process 700 of FIG. 7.

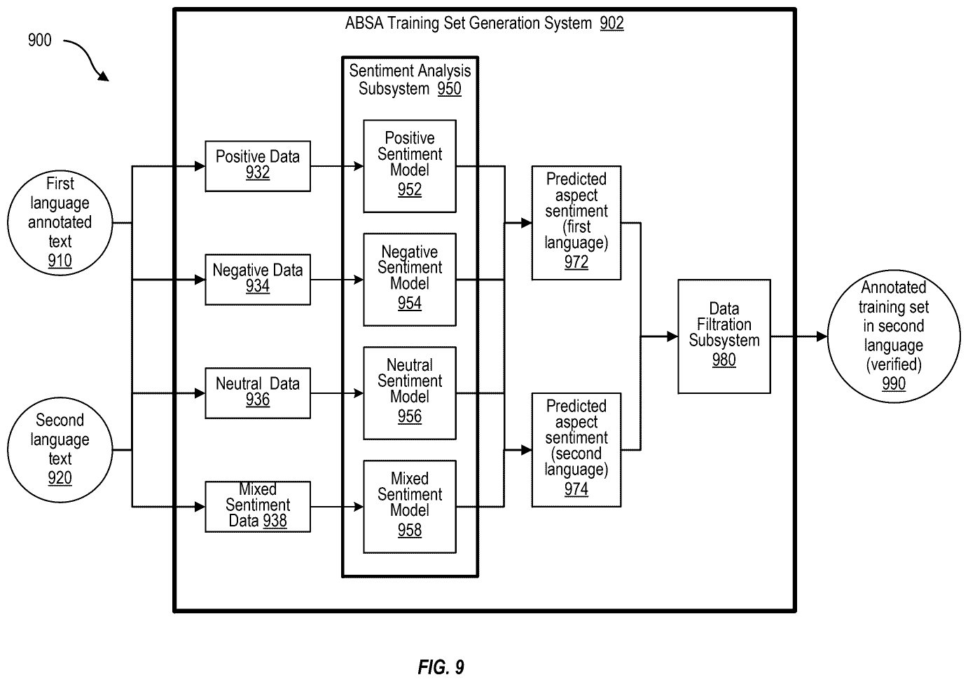

FIG. 9 is a simplified diagram illustrating an ABSA training set generation system, in accordance with embodiments. As shown in FIG. 9, an environment 900 includes an ABSA training set generation system 902. ABSA training set generation system 902 receives first language annotated text 910 as well as second language text 920, which may be a translation of the first language annotated text of a known parallel corpus of the first language annotated text, such as available from public databases, for example. First language annotated text may include, for example, a collection of text in the first language including annotations generated using an annotation model, a gold data set including a collection of text in the first language with verified annotations, or synthetic text generated using a generative LLM, as nonlimiting examples.

ABSA training set generation system 902 identifies aspects related to the different sentiment polarities (e.g., positive, negative, neutral, mixed sentiment) in the first language annotated text and the second language text into separate buckets of data (e.g., positive data 932, negative data 934, neutral data 936, and mixed sentiment data 938). The separate buckets of data are processed in parallel by different models in a sentiment analysis subsystem 950 (e.g., ABSA processing system). In embodiments, the different models in sentiment analysis subsystem 950 includes a positive sentiment model 952, a negative sentiment model 954, a neutral sentiment model 956, and a mixed sentiment model 958, wherein the different models operate in parallel.

The outputs from sentiment analysis subsystem 950 are split into predicted aspect sentiment 972 in the first language and predicted aspect sentiment 974 in the second language. The predicted aspect sentiments for the first and second languages are compared and processed in a data filtration system 980 such that the ABSA training set generation system 902 outputs an annotated training set 990 in the second language 990, which has been deemed accurate enough to be considered verified.

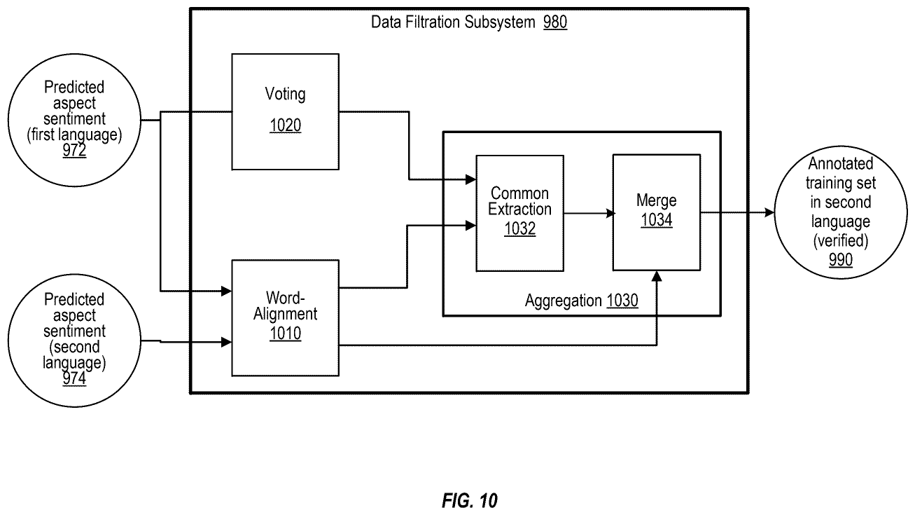

Further details of the data filtration subsystem FIG. 10 is a simplified diagram illustrating an example of a word alignment module of the data filtration subsystem in FIG. 9, according to certain embodiments. In embodiments, the data filtration subsystem may be particularly applicable when the first and second language text include synthetic data generated using ML models that generate parallel texts (e.g., English and translated non-English) with annotations.

As shown in FIGS. 9 and 10, data filtration subsystem 980 takes the predicted aspects for the first and second languages as input. In an embodiment, data filtration subsystem 980 includes a word alignment module 1010 configured for evaluating structural word alignment between the first and second language inputs. For example, word alignment module 1010 may validate whether key aspect terms in the first language are accurately preserved in the second language.

In embodiments, word-alignment module 1010 compares words present in the first language text and the second language text without annotations to ensure all translated words are correctly present in the second language text. Additionally, this word-alignment process may remove parts of the content (such as specific words or sentences) that are deemed to not be properly aligned, for example, due to improper translation. The removal, such as of missing words, non-captured aspects, or surplus words, may be implemented, for example, by using a filter with an 85% threshold for alignment results.

Further, the predicted sentiment in the first language may be subjected to a voting module 1020, such as based on multiple sentiment scoring models or application programming interfaces (APIs), to evaluate whether there is sufficient agreement between the multiple sentiment scoring models. For instance, voting module 1020 may be configured to use APIs to filter known unreliable data points in the first language text due to potentially non-perfect sentiment model.

Additionally or alternatively, voting module 1020 may utilize a sentiment model that may have been trained to predict aspect-sentiment annotations for a particular parallel corpus, such as English and Spanish. This sentiment model trained specifically for a particular combination of a first language and a second language (e.g., English and Spanish) may be referred to as a language-specific sentiment model. This language-specific sentiment model may include established historical or statistical information (e.g., classification pattern/result) from model training and particular characteristics of the data/text have certain probability of successful prediction useful for the filtering process. For example, a translated Spanish text with single word aspect (e.g., “friend”) may have a very high probability of successful prediction (e.g., 90%), while a translated Spanish text with multiple words (e.g., “work environment”) in certain context may have a relative low success rate (e.g., 50%). As a result, the language API may take the predicted aspect sentiment in the first language and generate a prediction success rate for the received aspect. This prediction success rate may be taken into consideration in downstream processing, as described below.

In embodiments, the results of evaluations by word alignment module 1010 and voting mechanism 1020 may be aggregated at an aggregation module 1030. For example, aggregation module may aggregate the output from the word alignment and voting modules by identifying the common portions in the first language. Based on extracting the common portions in the first language from common extraction module 1032, a merge module 1034 may select the corresponding non-English language with its aspect-sentiment annotations from the verified non-English predictions received from word-alignment module 1010. That is, a given predicted aspect sentiment in the second language may only be kept if it meets a minimum alignment threshold and sentiment confidence level. Thus, annotated training set in the second language includes English aspect-sentiment annotations and non-English aspect-sentiment annotations from which improperly translated aspects (e.g., missing words or surplus words) and non-perfect predictions (e.g., a polarity is wrongly classified) have been removed by the filtering process.

Table 5 below illustrates a non-capture example and a false positive/negative example that may be filtered by the word-alignment process and voting filtering process. The word-alignment process may filter out/remove the improperly translated aspects (e.g., non-captured aspects). Further, the voting process may filter the non-perfect predictions (e.g., a polarity is wrongly classified) based on historical/statistical information from a language-specific sentiment model.

TABLE 5

| | | | Parallel Non- | |
|---|---|---|---|---|
| | English | | English | |
| | Aggregate | Parallel Non- | Aggregate | Rejection |
| English Text | Predictions | English Text | Predictions | Reason |
| Bad roads, | [ | Russian Text: | [ | The aspect |
| disparate | { | [symbol] | { | ″communities″ |
| communities, | ″word″: | [symbol] | ″word″ : | is not captured |
| low average | ″roads″, | [symbol] | [symbol] , | here |
| income levels | ″entity″: | [symbol] | ″entity″: | The class for |
| and okayish | ″NEGATIVE″ | [symbol] | ″NEGATIVE″ | ″work |
| vehicles all | }, | [symbol] | } | environment″ |
| impair the | { | [symbol] | { | is wrongly |
| transport system | ″word″ : | [symbol] | ″word″: | classified as |
| and ultimately | ″communities″, | [symbol] | [symbol] | MIXED. |
| constrain | ″entity″: | [symbol] | ″entity″: | |
| economic | ″NEGATIVE″ | [symbol] | ″NEUTRAL″ | |
| output. | }, | [symbol] | }, | |
| Even with all | { | [symbol] | { | |
| that-excellent | ″word″: | [symbol] | ″word″: | |
| treatment, | ″vehicles″, | [symbol] | [symbol] | |
| wonderful | ″entity″: | Swedish Text: | [symbol] | |
| family and | ″NEUTRAL″ | Men även med allt | ″entity″: | |
| friends, | }, | det--utmärkt | ″NEGATIVE″ | |
| supportive work | { | behandling, | } | |
| environment-I | ″word″: | underbar familj och | ] | |
| did not make my | ″transport | vänner, stöttande | [ | |
| illness public | system″, | arbetsmiljö--så | { | |
| until relatively | ″entity″: | offentliggjorde jag | ″word″: | |
| late in life, and | ″NEGATIVE″ | inte min sjukdom | ″behandling″, | |
| that's because | } | förrän relativt sent i | ″entity″: | |
| the stigma | ] | livet, och det är på | ″POSITIVE″ | |
| against mental | [ | grund av att det | }, | |
| illness is so | { | stigma som omger | { | |
| powerful that I | ″word″: | psykisk sjukdom är | ″word″: | |
| didn′t feel safe | ″treatment″, | så kraftfullt att jag | ″familj″, | |
| with people | ″entity″: | inte kände mig | ″entity″: | |
| knowing. | ″POSITIVE″ | trygg med att folk | ″POSITIVE″ | |
| | }, | skulle veta. | }, | |
| | { | | { | |
| | ″word″ : | | ″word″: | |
| | ″family″, | | ″vänner″, | |
| | ″entity″: | | ″entity″: | |
| | ″POSITIVE″ | | ″POSITIVE″ | |
| | }, | | }, | |
| | { | | { | |
| | ″word″ : | | ″word″: | |
| | ″friends″. | | ″arbetsmiljö″, | |
| | ″entity″: | | ″entity″: | |
| | ″POSITIVE″ | | ″MIXED″ | |
| | } , | | } | |
| | { | | ] | |
| | ″word″: ″work | | | |
| | environment″, | | | |
| | ″entity″: | | | |
| | ″POSITIVE″ | | | |
| | } | | | |
| | ] | | | |

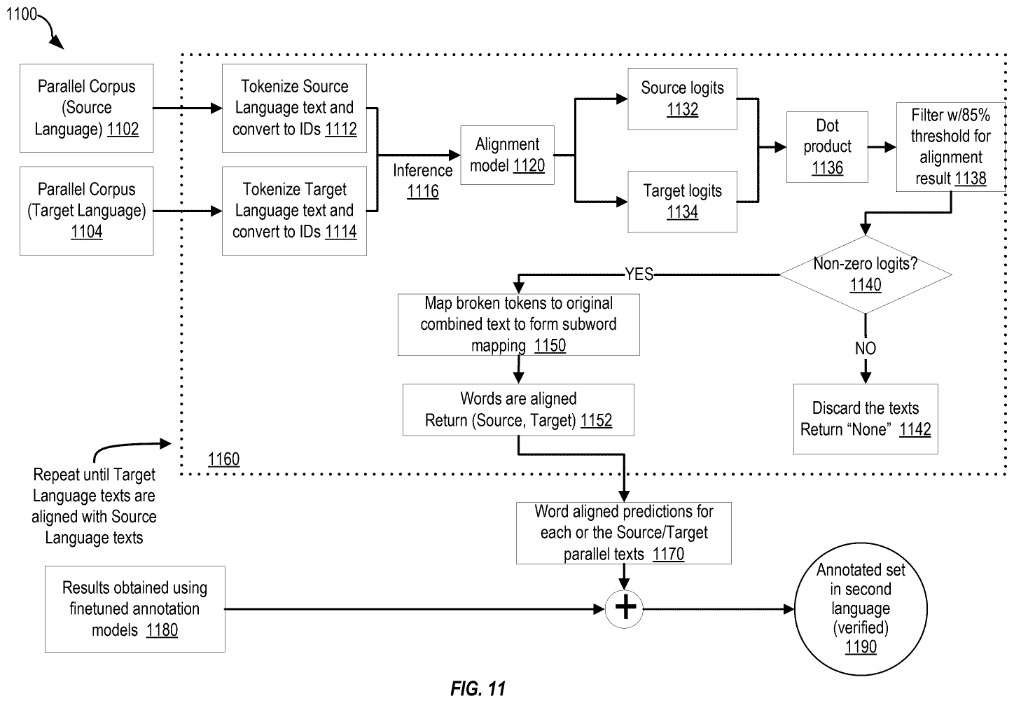

FIG. 11 is a simplified diagram illustrating an example of a word alignment module of the data filtration subsystem in FIG. 10, according to certain embodiments. The word alignment module may be implemented as word alignment module 1010 of data filtration subsystem 980 and may perform operations to align parallel texts in English and one or more non-English languages. This alignment may enable the ABSA-enabling system to determine whether aspect-sentiment annotations generated for English texts are supported by structurally and semantically aligned non-English content.

An alignment process 1100 begins with receiving a parallel corpus (first or source language) 1102 and a corresponding parallel corpus (second or target language) 1104, which may include unannotated sentence pairs previously identified as translations. The first and second language texts may be separately tokenized and converted to numerical representations using language-specific tokenizers. These operations may be performed by tokenization and ID conversion modules 1112 and 1114, which may output token ID sequences suitable for processing by the alignment model. In some embodiments, the tokenizers may implement subword-level tokenization (e.g., BPE or WordPiece) consistent with the tokenization scheme used during model pretraining.

The tokenized inputs are passed into alignment model 1120, which may generate contextual representations such as source logits 1132 and target logits 1134 extracted from an intermediate transformer layer (e.g., the 8th layer of an exemplary alignment model). These logits may represent high-dimensional embeddings for each token in the English and non-English sentences, respectively. A dot product operation 1136 is performed to calculate similarity scores between each source and target token. The resulting scores are passed through a filtering mechanism, such as alignment threshold filter 1138, that may apply a confidence threshold (e.g., 85%) to determine if sufficient alignment has been achieved. In some embodiments, this process may be repeated iteratively across multiple parallel sentence pairs to maximize valid alignment coverage.

Following score computation, the system makes a determination whether the alignment result is meaningful. A control operation 1140 may evaluate whether non-zero logits exist for at least one pair of source-target tokens, indicating successful alignment. If no such logits are found, the sentence pair may be discarded using discard module 1142, and no further processing is performed on that sample. For successfully aligned pairs, the system invokes mapping module 1150, which reconstructs the original word structure from subword tokens using pre-alignment mappings. This mapping restores the tokens to their combined text form for readability and downstream use. The aligned words are then be returned as source-target alignment pairs by alignment output module 1152.

The aligned sentence pairs are then passed to a sentiment annotation post-processing stage. For each successfully aligned first and second language sentence pair, word aligned predictions 1170 are generated. These predictions are then combined with polarity predictions, such as obtained from specialized ABSA models 1180, which may include polarity-specific models trained using English and Spanish annotations. The combination of aligned sentence pairs and their corresponding sentiment annotations are merged to aggregate validated text pairs and sentiment information into final common predictions 1190, which may be further used by, for example, aggregation module (e.g., 1030) of FIG. 10 to produce the refined multilingual training dataset.

It is recognized herein that, while the present approach is described in the context of generating training sets for ABSA, other language models requiring classification of large, varied training sets may benefit from a similar approach. For example, the disclosed techniques may be applied to other applications involving classification in addition to ABSA, such as NER (Named Entity Recognition), KPE (Key Phrase Extraction), SLSA (Sentence Level Sentiment Analysis), PII (Personally Identifiable Information), PHI (Protected Health Information), etc.

In certain embodiments, a multilingual ABSA training data generation and filtration system described herein automates the creation of aspect-sentiment-labeled sentences in English using a fine-tuned, instruction-based generative model and then projects those annotations into other languages using a combination of translation, alignment, and verification steps. The translated content is not accepted blindly; instead, the translated, non-English content undergoes a rigorous validation process that evaluates whether the non-English version contains the same aspect terms and preserves the sentiment meaning as expressed in the original English. In certain embodiments, these results are achieved through a dual-stream validation approach, where alignment models may certify the structural presence of aspect terms, and sentiment scoring models (e.g., LaBSE variants) may verify polarity consistency. The result is a highly filtered, high-confidence multilingual training dataset suitable for implementing multilingual ABSA.

The pipeline described herein may enable developers to produce large-scale multilingual ABSA datasets without requiring native-language annotators for each language. It may support the generation of annotations for aspect terms directly within translated texts while ensuring that sentiment assignments remain accurate and trustworthy. The system is also extensible—it may incorporate polarity-specific sentence embedding models and multiple model checkpoints to handle varying confidence levels and sentiment intensities. By generating, validating, and refining annotations in a structured and automated manner, the presently described system enables scalable, cost-effective expansion of ABSA models into low-resource languages, which may ultimately improve cross-lingual NLP capabilities in real-world applications such as customer feedback analysis, social media monitoring, and product review mining in a plurality of languages.

The disclosed techniques for multilingual aspect-based sentiment analysis (ABSA) data generation and filtration offer several technical advantages over conventional annotation pipelines. In some embodiments, the system may enable a fully automated process for generating and validating multilingual aspect-sentiment annotations, potentially reducing or eliminating the need for manual labeling or post-translation review. A generative instruction-based model may be used to create synthetic English training samples that are contextually rich and tailored to specific aspect-polarity combinations. This approach may allow for flexible and scalable dataset expansion, particularly for domain-specific use cases. Additionally, by anchoring multilingual annotation to high-confidence English reference data, the system may mitigate issues commonly associated with low-resource translation or cross-lingual transfer techniques.

The system may further improve annotation quality by implementing a dual-stream validation process that includes structural word alignment and sentiment-based filtering. A word alignment module may validate whether key aspect terms in the English text are accurately preserved in the translated version, while a voting mechanism may evaluate sentiment reliability based on agreement between multiple sentiment scoring models or APIs. In some cases, predictions may be retained only if they meet a minimum alignment threshold and sentiment confidence level. This two-stage filtering mechanism may enhance the consistency, trustworthiness, and linguistic accuracy of the final multilingual annotations. Additionally, the system may fine-tune separate sentiment analysis models for each polarity class, such as positive, negative, neutral, and mixed, which may result in more precise sentiment prediction across a wider variety of sentence structures and languages.

These techniques may collectively reduce reliance on native-language annotators, improve the scalability of ABSA model development, and enhance the quality of cross-lingual training datasets. By supporting automatic generation and validation of aspect-sentiment annotations across multiple languages, the system may enable faster development of sentiment models with greater multilingual coverage. This, in turn, may contribute to improved model accuracy, reduced annotation costs, and increased applicability of ABSA systems in global customer feedback, product review analysis, and other sentiment-driven applications.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

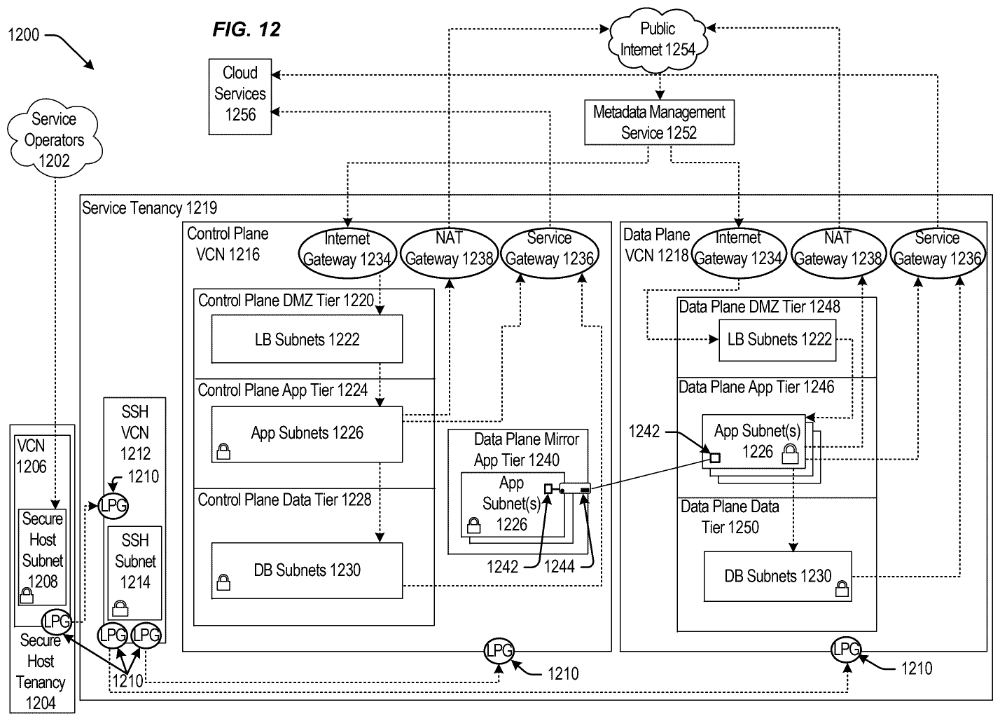

FIG. 12 is a block diagram 1200 illustrating an example pattern of an IaaS architecture, according to at least one embodiment. Service operators 1202 can be communicatively coupled to a secure host tenancy 1204 that can include a virtual cloud network (VCN) 1206 and a secure host subnet 1208. In some examples, the service operators 1202 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1206 and/or the Internet.

The VCN 1206 can include a local peering gateway (LPG) 1210 that can be communicatively coupled to a secure shell (SSH) VCN 1212 via an LPG 1210 contained in the SSH VCN 1212. The SSH VCN 1212 can include an SSH subnet 1214, and the SSH VCN 1212 can be communicatively coupled to a control plane VCN 1216 via the LPG 1210 contained in the control plane VCN 1216. Also, the SSH VCN 1212 can be communicatively coupled to a data plane VCN 1218 via an LPG 1210. The control plane VCN 1216 and the data plane VCN 1218 can be contained in a service tenancy 1219 that can be owned and/or operated by the IaaS provider.

The control plane VCN 1216 can include a control plane demilitarized zone (DMZ) tier 1220 that acts as a perimeter network (e.g., portions of a corporate network between the corporate intranet and external networks). The DMZ-based servers may have restricted responsibilities and help keep breaches contained. Additionally, the DMZ tier 1220 can include one or more load balancer (LB) subnet(s) 1222, a control plane app tier 1224 that can include app subnet(s) 1226, a control plane data tier 1228 that can include database (DB) subnet(s) 1230 (e.g., frontend DB subnet(s) and/or backend DB subnet(s)). The LB subnet(s) 1222 contained in the control plane DMZ tier 1220 can be communicatively coupled to the app subnet(s) 1226 contained in the control plane app tier 1224 and an Internet gateway 1234 that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238. The control plane VCN 1216 can include the service gateway 1236 and the NAT gateway 1238.

The control plane VCN 1216 can include a data plane mirror app tier 1240 that can include app subnet(s) 1226. The app subnet(s) 1226 contained in the data plane mirror app tier 1240 can include a virtual network interface controller (VNIC) 1242 that can execute a compute instance 1244. The compute instance 1244 can communicatively couple the app subnet(s) 1226 of the data plane mirror app tier 1240 to app subnet(s) 1226 that can be contained in a data plane app tier 1246.

The data plane VCN 1218 can include the data plane app tier 1246, a data plane DMZ tier 1248, and a data plane data tier 1250. The data plane DMZ tier 1248 can include LB subnet(s) 1222 that can be communicatively coupled to the app subnet(s) 1226 of the data plane app tier 1246 and the Internet gateway 1234 of the data plane VCN 1218. The app subnet(s) 1226 can be communicatively coupled to the service gateway 1236 of the data plane VCN 1218 and the NAT gateway 1238 of the data plane VCN 1218. The data plane data tier 1250 can also include the DB subnet(s) 1230 that can be communicatively coupled to the app subnet(s) 1226 of the data plane app tier 1246.

The Internet gateway 1234 of the control plane VCN 1216 and of the data plane VCN 1218 can be communicatively coupled to a metadata management service 1252 that can be communicatively coupled to public Internet 1254. Public Internet 1254 can be communicatively coupled to the NAT gateway 1238 of the control plane VCN 1216 and of the data plane VCN 1218. The service gateway 1236 of the control plane VCN 1216 and of the data plane VCN 1218 can be communicatively coupled to cloud services 1256.

In some examples, the service gateway 1236 of the control plane VCN 1216 or of the data plane VCN 1218 can make application programming interface (API) calls to cloud services 1256 without going through public Internet 1254. The API calls to cloud services 1256 from the service gateway 1236 can be one-way: the service gateway 1236 can make API calls to cloud services 1256, and cloud services 1256 can send requested data to the service gateway 1236. But, cloud services 1256 may not initiate API calls to the service gateway 1236.

In some examples, the secure host tenancy 1204 can be directly connected to the service tenancy 1219, which may be otherwise isolated. The secure host subnet 1208 can communicate with the SSH subnet 1214 through an LPG 1210 that may enable two-way communication over an otherwise isolated system. Connecting the secure host subnet 1208 to the SSH subnet 1214 may give the secure host subnet 1208 access to other entities within the service tenancy 1219.

The control plane VCN 1216 may allow users of the service tenancy 1219 to set up or otherwise provision desired resources. Desired resources provisioned in the control plane VCN 1216 may be deployed or otherwise used in the data plane VCN 1218. In some examples, the control plane VCN 1216 can be isolated from the data plane VCN 1218, and the data plane mirror app tier 1240 of the control plane VCN 1216 can communicate with the data plane app tier 1246 of the data plane VCN 1218 via VNICs 1242 that can be contained in the data plane mirror app tier 1240 and the data plane app tier 1246.

In some examples, users of the system, or customers, can make requests, for example create, read, update, or delete (CRUD) operations, through public Internet 1254 that can communicate the requests to the metadata management service 1252. The metadata management service 1252 can communicate the request to the control plane VCN 1216 through the Internet gateway 1234. The request can be received by the LB subnet(s) 1222 contained in the control plane DMZ tier 1220. The LB subnet(s) 1222 may determine that the request is valid, and in response to this determination, the LB subnet(s) 1222 can transmit the request to app subnet(s) 1226 contained in the control plane app tier 1224. If the request is validated and requires a call to public Internet 1254, the call to public Internet 1254 may be transmitted to the NAT gateway 1238 that can make the call to public Internet 1254. Metadata that may be desired to be stored by the request can be stored in the DB subnet(s) 1230.

In some examples, the data plane mirror app tier 1240 can facilitate direct communication between the control plane VCN 1216 and the data plane VCN 1218. For example, changes, updates, or other suitable modifications to configuration may be desired to be applied to the resources contained in the data plane VCN 1218. Via a VNIC 1242, the control plane VCN 1216 can directly communicate with, and can thereby execute the changes, updates, or other suitable modifications to configuration to, resources contained in the data plane VCN 1218.

In some embodiments, the control plane VCN 1216 and the data plane VCN 1218 can be contained in the service tenancy 1219. In this case, the user, or the customer, of the system may not own or operate either the control plane VCN 1216 or the data plane VCN 1218. Instead, the IaaS provider may own or operate the control plane VCN 1216 and the data plane VCN 1218, both of which may be contained in the service tenancy 1219. This embodiment can enable isolation of networks that may prevent users or customers from interacting with other users', or other customers', resources. Also, this embodiment may allow users or customers of the system to store databases privately without needing to rely on public Internet 1254, which may not have a desired level of threat prevention, for storage.

In other embodiments, the LB subnet(s) 1222 contained in the control plane VCN 1216 can be configured to receive a signal from the service gateway 1236. In this embodiment, the control plane VCN 1216 and the data plane VCN 1218 may be configured to be called by a customer of the IaaS provider without calling public Internet 1254. Customers of the IaaS provider may desire this embodiment since database(s) that the customers use may be controlled by the IaaS provider and may be stored on the service tenancy 1219, which may be isolated from public Internet 1254.

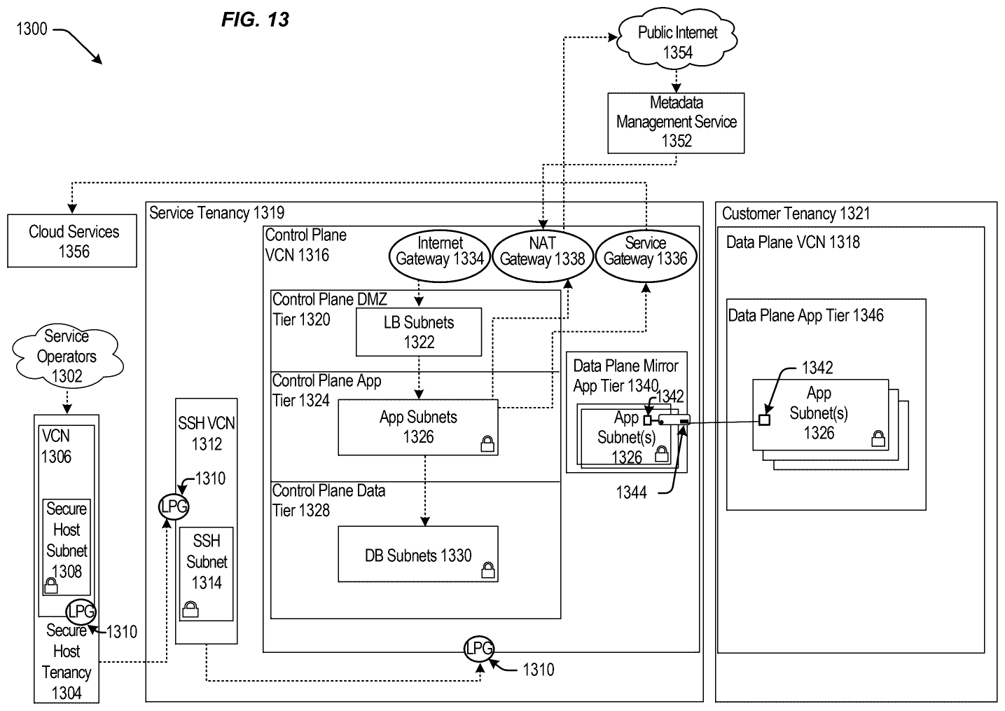

FIG. 13 is a block diagram 1300 illustrating another example pattern of an IaaS architecture, according to at least one embodiment. Service operators 1302 (e.g., service operators 1202 of FIG. 12) can be communicatively coupled to a secure host tenancy 1304 (e.g., the secure host tenancy 1204 of FIG. 12) that can include a virtual cloud network (VCN) 1306 (e.g., the VCN 1206 of FIG. 12) and a secure host subnet 1308 (e.g., the secure host subnet 1208 of FIG. 12). The VCN 1306 can include a local peering gateway (LPG) 1310 (e.g., the LPG 1210 of FIG. 12) that can be communicatively coupled to a secure shell (SSH) VCN 1312 (e.g., the SSH VCN 1212 of FIG. 12) via an LPG 1210 contained in the SSH VCN 1312. The SSH VCN 1312 can include an SSH subnet 1314 (e.g., the SSH subnet 1214 of FIG. 12), and the SSH VCN 1312 can be communicatively coupled to a control plane VCN 1316 (e.g., the control plane VCN 1216 of FIG. 12) via an LPG 1310 contained in the control plane VCN 1316. The control plane VCN 1316 can be contained in a service tenancy 1319 (e.g., the service tenancy 1219 of FIG. 12), and the data plane VCN 1318 (e.g., the data plane VCN 1218 of FIG. 12) can be contained in a customer tenancy 1321 that may be owned or operated by users, or customers, of the system.

The control plane VCN 1316 can include a control plane DMZ tier 1320 (e.g., the control plane DMZ tier 1220 of FIG. 12) that can include LB subnet(s) 1322 (e.g., LB subnet(s) 1222 of FIG. 12), a control plane app tier 1324 (e.g., the control plane app tier 1224 of FIG. 12) that can include app subnet(s) 1326 (e.g., app subnet(s) 1226 of FIG. 12), a control plane data tier 1328 (e.g., the control plane data tier 1228 of FIG. 12) that can include database (DB) subnet(s) 1330 (e.g., similar to DB subnet(s) 1230 of FIG. 12). The LB subnet(s) 1322 contained in the control plane DMZ tier 1320 can be communicatively coupled to the app subnet(s) 1326 contained in the control plane app tier 1324 and an Internet gateway 1334 (e.g., the Internet gateway 1234 of FIG. 12) that can be contained in the control plane VCN 1316, and the app subnet(s) 1326 can be communicatively coupled to the DB subnet(s) 1330 contained in the control plane data tier 1328 and a service gateway 1336 (e.g., the service gateway 1236 of FIG. 12) and a network address translation (NAT) gateway 1338 (e.g., the NAT gateway 1238 of FIG. 12). The control plane VCN 1316 can include the service gateway 1336 and the NAT gateway 1338.

The control plane VCN 1316 can include a data plane mirror app tier 1340 (e.g., the data plane mirror app tier 1240 of FIG. 12) that can include app subnet(s) 1326. The app subnet(s) 1326 contained in the data plane mirror app tier 1340 can include a virtual network interface controller (VNIC) 1342 (e.g., the VNIC of 1242) that can execute a compute instance 1344 (e.g., similar to the compute instance 1244 of FIG. 12). The compute instance 1344 can facilitate communication between the app subnet(s) 1326 of the data plane mirror app tier 1340 and the app subnet(s) 1326 that can be contained in a data plane app tier 1346 (e.g., the data plane app tier 1246 of FIG. 12) via the VNIC 1342 contained in the data plane mirror app tier 1340 and the VNIC 1342 contained in the data plane app tier 1346.

The Internet gateway 1334 contained in the control plane VCN 1316 can be communicatively coupled to a metadata management service 1352 (e.g., the metadata management service 1252 of FIG. 12) that can be communicatively coupled to public Internet 1354 (e.g., public Internet 1254 of FIG. 12). Public Internet 1354 can be communicatively coupled to the NAT gateway 1338 contained in the control plane VCN 1316. The service gateway 1336 contained in the control plane VCN 1316 can be communicatively coupled to cloud services 1356 (e.g., cloud services 1256 of FIG. 12).

In some examples, the data plane VCN 1318 can be contained in the customer tenancy 1321. In this case, the IaaS provider may provide the control plane VCN 1316 for each customer, and the IaaS provider may, for each customer, set up a unique compute instance 1344 that is contained in the service tenancy 1319. Each compute instance 1344 may allow communication between the control plane VCN 1316, contained in the service tenancy 1319, and the data plane VCN 1318 that is contained in the customer tenancy 1321. The compute instance 1344 may allow resources, that are provisioned in the control plane VCN 1316 that is contained in the service tenancy 1319, to be deployed or otherwise used in the data plane VCN 1318 that is contained in the customer tenancy 1321.

In other examples, the customer of the IaaS provider may have databases that live in the customer tenancy 1321. In this example, the control plane VCN 1316 can include the data plane mirror app tier 1340 that can include app subnet(s) 1326. The data plane mirror app tier 1340 can reside in the data plane VCN 1318, but the data plane mirror app tier 1340 may not live in the data plane VCN 1318. That is, the data plane mirror app tier 1340 may have access to the customer tenancy 1321, but the data plane mirror app tier 1340 may not exist in the data plane VCN 1318 or be owned or operated by the customer of the IaaS provider. The data plane mirror app tier 1340 may be configured to make calls to the data plane VCN 1318 but may not be configured to make calls to any entity contained in the control plane VCN 1316. The customer may desire to deploy or otherwise use resources in the data plane VCN 1318 that are provisioned in the control plane VCN 1316, and the data plane mirror app tier 1340 can facilitate the desired deployment, or other usage of resources, of the customer.

In some embodiments, the customer of the IaaS provider can apply filters to the data plane VCN 1318. In this embodiment, the customer can determine what the data plane VCN 1318 can access, and the customer may restrict access to public Internet 1354 from the data plane VCN 1318. The IaaS provider may not be able to apply filters or otherwise control access of the data plane VCN 1318 to any outside networks or databases. Applying filters and controls by the customer onto the data plane VCN 1318, contained in the customer tenancy 1321, can help isolate the data plane VCN 1318 from other customers and from public Internet 1354.

In some embodiments, cloud services 1356 can be called by the service gateway 1336 to access services that may not exist on public Internet 1354, on the control plane VCN 1316, or on the data plane VCN 1318. The connection between cloud services 1356 and the control plane VCN 1316 or the data plane VCN 1318 may not be live or continuous. Cloud services 1356 may exist on a different network owned or operated by the IaaS provider. Cloud services 1356 may be configured to receive calls from the service gateway 1336 and may be configured to not receive calls from public Internet 1354. Some cloud services 1356 may be isolated from other cloud services 1356, and the control plane VCN 1316 may be isolated from cloud services 1356 that may not be in the same region as the control plane VCN 1316. For example, the control plane VCN 1316 may be located in “Region 1,” and cloud service “Deployment 12,” may be located in Region 1 and in “Region 2.” If a call to Deployment 12 is made by the service gateway 1336 contained in the control plane VCN 1316 located in Region 1, the call may be transmitted to Deployment 12 in Region 1. In this example, the control plane VCN 1316, or Deployment 12 in Region 1, may not be communicatively coupled to, or otherwise in communication with, Deployment 12 in Region 2.

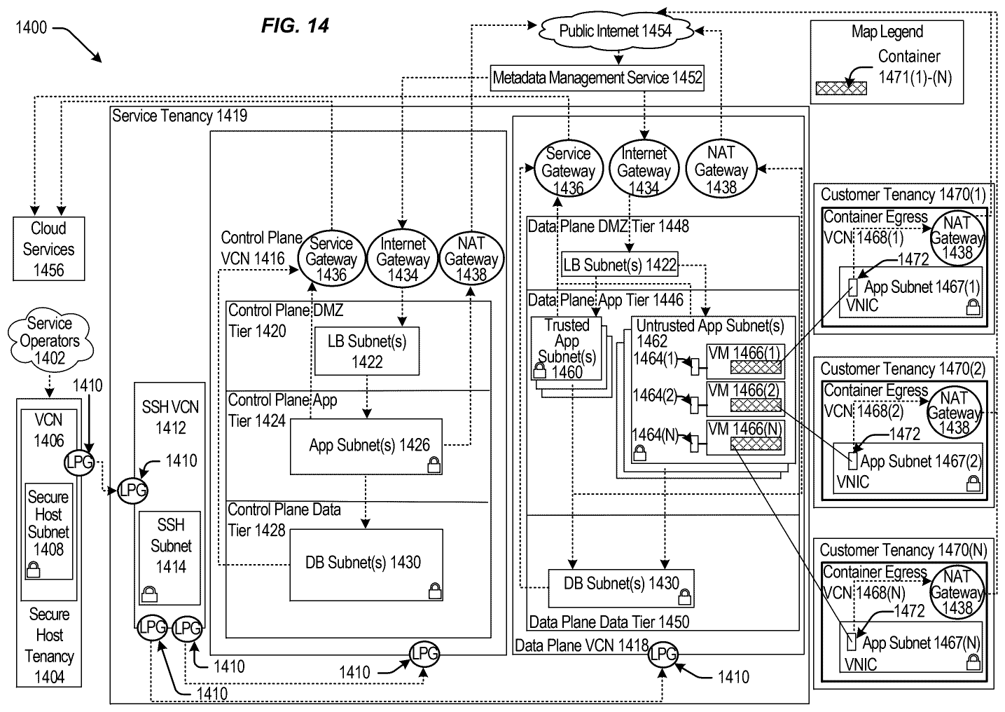

FIG. 14 is a block diagram 1400 illustrating another example pattern of an IaaS architecture, according to at least one embodiment. Service operators 1402 (e.g., service operators 1202 of FIG. 12) can be communicatively coupled to a secure host tenancy 1404 (e.g., the secure host tenancy 1204 of FIG. 12) that can include a virtual cloud network (VCN) 1406 (e.g., the VCN 1206 of FIG. 12) and a secure host subnet 1408 (e.g., the secure host subnet 1208 of FIG. 12). The VCN 1406 can include an LPG 1410 (e.g., the LPG 1210 of FIG. 12) that can be communicatively coupled to an SSH VCN 1412 (e.g., the SSH VCN 1212 of FIG. 12) via an LPG 1410 contained in the SSH VCN 1412. The SSH VCN 1412 can include an SSH subnet 1414 (e.g., the SSH subnet 1214 of FIG. 12), and the SSH VCN 1412 can be communicatively coupled to a control plane VCN 1416 (e.g., the control plane VCN 1216 of FIG. 12) via an LPG 1410 contained in the control plane VCN 1416 and to a data plane VCN 1418 (e.g., the data plane 1218 of FIG. 12) via an LPG 1410 contained in the data plane VCN 1418. The control plane VCN 1416 and the data plane VCN 1418 can be contained in a service tenancy 1419 (e.g., the service tenancy 1219 of FIG. 12).

The control plane VCN 1416 can include a control plane DMZ tier 1420 (e.g., the control plane DMZ tier 1220 of FIG. 12) that can include load balancer (LB) subnet(s) 1422 (e.g., LB subnet(s) 1222 of FIG. 12), a control plane app tier 1424 (e.g., the control plane app tier 1224 of FIG. 12) that can include app subnet(s) 1426 (e.g., similar to app subnet(s) 1226 of FIG. 12), a control plane data tier 1428 (e.g., the control plane data tier 1228 of FIG. 12) that can include DB subnet(s) 1430. The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1234 of FIG. 12) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 12) and a network address translation (NAT) gateway 1438 (e.g., the NAT gateway 1238 of FIG. 12). The control plane VCN 1416 can include the service gateway 1436 and the NAT gateway 1438.

The data plane VCN 1418 can include a data plane app tier 1446 (e.g., the data plane app tier 1246 of FIG. 12), a data plane DMZ tier 1448 (e.g., the data plane DMZ tier 1248 of FIG. 12), and a data plane data tier 1450 (e.g., the data plane data tier 1250 of FIG. 12). The data plane DMZ tier 1448 can include LB subnet(s) 1422 that can be communicatively coupled to trusted app subnet(s) 1460 and untrusted app subnet(s) 1462 of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include one or more primary VNICs 1464(1)-(N) that can be communicatively coupled to tenant virtual machines (VMs) 1466(1)-(N). Each tenant VM 1466(1)-(N) can be communicatively coupled to a respective app subnet 1467(1)-(N) that can be contained in respective container egress VCNs 1468(1)-(N) that can be contained in respective customer tenancies 1470(1)-(N). Respective secondary VNICs 1472(1)-(N) can facilitate communication between the untrusted app subnet(s) 1462 contained in the data plane VCN 1418 and the app subnet contained in the container egress VCNs 1468(1)-(N). Each container egress VCNs 1468(1)-(N) can include a NAT gateway 1438 that can be communicatively coupled to public Internet 1454 (e.g., public Internet 1254 of FIG. 12).

The Internet gateway 1434 contained in the control plane VCN 1416 and contained in the data plane VCN 1418 can be communicatively coupled to a metadata management service 1452 (e.g., the metadata management system 1252 of FIG. 12) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some embodiments, the data plane VCN 1418 can be integrated with customer tenancies 1470. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1446. Code to run the function may be executed in the VMs 1466(1)-(N), and the code may not be configured to run anywhere else on the data plane VCN 1418. Each VM 1466(1)-(N) may be connected to one customer tenancy 1470. Respective containers 1471(1)-(N) contained in the VMs 1466(1)-(N) may be configured to run the code. In this case, there can be a dual isolation (e.g., the containers 1471(1)-(N) running code, where the containers 1471(1)-(N) may be contained in at least the VM 1466(1)-(N) that are contained in the untrusted app subnet(s) 1462), which may help prevent incorrect or otherwise undesirable code from damaging the network of the IaaS provider or from damaging a network of a different customer. The containers 1471(1)-(N) may be communicatively coupled to the customer tenancy 1470 and may be configured to transmit or receive data from the customer tenancy 1470. The containers 1471(1)-(N) may not be configured to transmit or receive data from any other entity in the data plane VCN 1418. Upon completion of running the code, the IaaS provider may kill or otherwise dispose of the containers 1471(1)-(N).

In some embodiments, the trusted app subnet(s) 1460 may run code that may be owned or operated by the IaaS provider. In this embodiment, the trusted app subnet(s) 1460 may be communicatively coupled to the DB subnet(s) 1430 and be configured to execute CRUD operations in the DB subnet(s) 1430. The untrusted app subnet(s) 1462 may be communicatively coupled to the DB subnet(s) 1430, but in this embodiment, the untrusted app subnet(s) may be configured to execute read operations in the DB subnet(s) 1430. The containers 1471(1)-(N) that can be contained in the VM 1466(1)-(N) of each customer and that may run code from the customer may not be communicatively coupled with the DB subnet(s) 1430.

In other embodiments, the control plane VCN 1416 and the data plane VCN 1418 may not be directly communicatively coupled. In this embodiment, there may be no direct communication between the control plane VCN 1416 and the data plane VCN 1418. However, communication can occur indirectly through at least one method. An LPG 1410 may be established by the IaaS provider that can facilitate communication between the control plane VCN 1416 and the data plane VCN 1418. In another example, the control plane VCN 1416 or the data plane VCN 1418 can make a call to cloud services 1456 via the service gateway 1436. For example, a call to cloud services 1456 from the control plane VCN 1416 can include a request for a service that can communicate with the data plane VCN 1418.

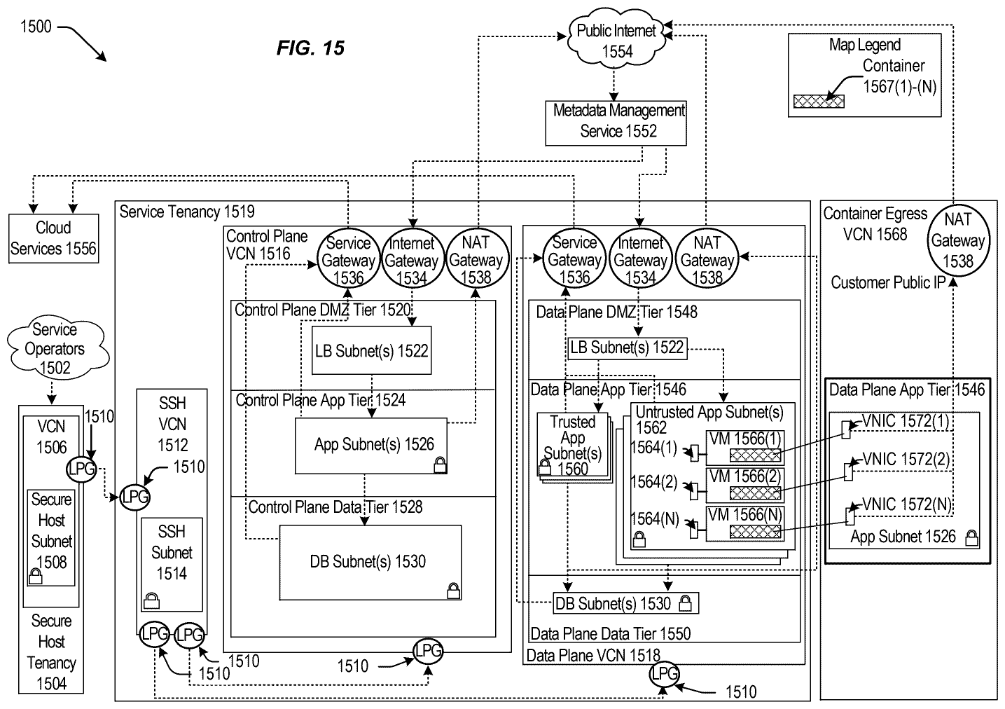

FIG. 15 is a block diagram 1500 illustrating another example pattern of an IaaS architecture, according to at least one embodiment. Service operators 1502 (e.g., service operators 1202 of FIG. 12) can be communicatively coupled to a secure host tenancy 1504 (e.g., the secure host tenancy 1204 of FIG. 12) that can include a virtual cloud network (VCN) 1506 (e.g., the VCN 1206 of FIG. 12) and a secure host subnet 1508 (e.g., the secure host subnet 1208 of FIG. 12). The VCN 1506 can include an LPG 1510 (e.g., the LPG 1210 of FIG. 12) that can be communicatively coupled to an SSH VCN 1512 (e.g., the SSH VCN 1212 of FIG. 12) via an LPG 1510 contained in the SSH VCN 1512. The SSH VCN 1512 can include an SSH subnet 1514 (e.g., the SSH subnet 1214 of FIG. 12), and the SSH VCN 1512 can be communicatively coupled to a control plane VCN 1516 (e.g., the control plane VCN 1216 of FIG. 12) via an LPG 1510 contained in the control plane VCN 1516 and to a data plane VCN 1518 (e.g., the data plane 1218 of FIG. 12) via an LPG 1510 contained in the data plane VCN 1518. The control plane VCN 1516 and the data plane VCN 1518 can be contained in a service tenancy 1519 (e.g., the service tenancy 1219 of FIG. 12).

The control plane VCN 1516 can include a control plane DMZ tier 1520 (e.g., the control plane DMZ tier 1220 of FIG. 12) that can include LB subnet(s) 1522 (e.g., LB subnet(s) 1222 of FIG. 12), a control plane app tier 1524 (e.g., the control plane app tier 1224 of FIG. 12) that can include app subnet(s) 1526 (e.g., app subnet(s) 1226 of FIG. 12), a control plane data tier 1528 (e.g., the control plane data tier 1228 of FIG. 12) that can include DB subnet(s) 1530 (e.g., DB subnet(s) 1430 of FIG. 14). The LB subnet(s) 1522 contained in the control plane DMZ tier 1520 can be communicatively coupled to the app subnet(s) 1526 contained in the control plane app tier 1524 and to an Internet gateway 1534 (e.g., the Internet gateway 1234 of FIG. 12) that can be contained in the control plane VCN 1516, and the app subnet(s) 1526 can be communicatively coupled to the DB subnet(s) 1530 contained in the control plane data tier 1528 and to a service gateway 1536 (e.g., the service gateway of FIG. 12) and a network address translation (NAT) gateway 1538 (e.g., the NAT gateway 1238 of FIG. 12). The control plane VCN 1516 can include the service gateway 1536 and the NAT gateway 1538.

The data plane VCN 1518 can include a data plane app tier 1546 (e.g., the data plane app tier 1246 of FIG. 12), a data plane DMZ tier 1548 (e.g., the data plane DMZ tier 1248 of FIG. 12), and a data plane data tier 1550 (e.g., the data plane data tier 1250 of FIG. 12). The data plane DMZ tier 1548 can include LB subnet(s) 1522 that can be communicatively coupled to trusted app subnet(s) 1560 (e.g., trusted app subnet(s) 1460 of FIG. 14) and untrusted app subnet(s) 1562 (e.g., untrusted app subnet(s) 1462 of FIG. 14) of the data plane app tier 1546 and the Internet gateway 1534 contained in the data plane VCN 1518. The trusted app subnet(s) 1560 can be communicatively coupled to the service gateway 1536 contained in the data plane VCN 1518, the NAT gateway 1538 contained in the data plane VCN 1518, and DB subnet(s) 1530 contained in the data plane data tier 1550. The untrusted app subnet(s) 1562 can be communicatively coupled to the service gateway 1536 contained in the data plane VCN 1518 and DB subnet(s) 1530 contained in the data plane data tier 1550. The data plane data tier 1550 can include DB subnet(s) 1530 that can be communicatively coupled to the service gateway 1536 contained in the data plane VCN 1518.

The untrusted app subnet(s) 1562 can include primary VNICs 1564(1)-(N) that can be communicatively coupled to tenant virtual machines (VMs) 1566(1)-(N) residing within the untrusted app subnet(s) 1562. Each tenant VM 1566(1)-(N) can run code in a respective container 1567(1)-(N), and be communicatively coupled to an app subnet 1526 that can be contained in a data plane app tier 1546 that can be contained in a container egress VCN 1568. Respective secondary VNICs 1572(1)-(N) can facilitate communication between the untrusted app subnet(s) 1562 contained in the data plane VCN 1518 and the app subnet contained in the container egress VCN 1568. The container egress VCN can include a NAT gateway 1538 that can be communicatively coupled to public Internet 1554 (e.g., public Internet 1254 of FIG. 12).

The Internet gateway 1534 contained in the control plane VCN 1516 and contained in the data plane VCN 1518 can be communicatively coupled to a metadata management service 1552 (e.g., the metadata management system 1252 of FIG. 12) that can be communicatively coupled to public Internet 1554. Public Internet 1554 can be communicatively coupled to the NAT gateway 1538 contained in the control plane VCN 1516 and contained in the data plane VCN 1518. The service gateway 1536 contained in the control plane VCN 1516 and contained in the data plane VCN 1518 can be communicatively coupled to cloud services 1556.

In some examples, the pattern illustrated by the architecture of block diagram 1500 of FIG. 15 may be considered an exception to the pattern illustrated by the architecture of block diagram 1400 of FIG. 14 and may be desirable for a customer of the IaaS provider if the IaaS provider cannot directly communicate with the customer (e.g., a disconnected region). The respective containers 1567(1)-(N) that are contained in the VMs 1566(1)-(N) for each customer can be accessed in real-time by the customer. The containers 1567(1)-(N) may be configured to make calls to respective secondary VNICs 1572(1)-(N) contained in app subnet(s) 1526 of the data plane app tier 1546 that can be contained in the container egress VCN 1568. The secondary VNICs 1572(1)-(N) can transmit the calls to the NAT gateway 1538 that may transmit the calls to public Internet 1554. In this example, the containers 1567(1)-(N) that can be accessed in real-time by the customer can be isolated from the control plane VCN 1516 and can be isolated from other entities contained in the data plane VCN 1518. The containers 1567(1)-(N) may also be isolated from resources from other customers.

In other examples, the customer can use the containers 1567(1)-(N) to call cloud services 1556. In this example, the customer may run code in the containers 1567(1)-(N) that requests a service from cloud services 1556. The containers 1567(1)-(N) can transmit this request to the secondary VNICs 1572(1)-(N) that can transmit the request to the NAT gateway that can transmit the request to public Internet 1554. Public Internet 1554 can transmit the request to LB subnet(s) 1522 contained in the control plane VCN 1516 via the Internet gateway 1534. In response to determining the request is valid, the LB subnet(s) can transmit the request to app subnet(s) 1526 that can transmit the request to cloud services 1556 via the service gateway 1536.

It should be appreciated that IaaS architectures 1200, 1300, 1400, 1500 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

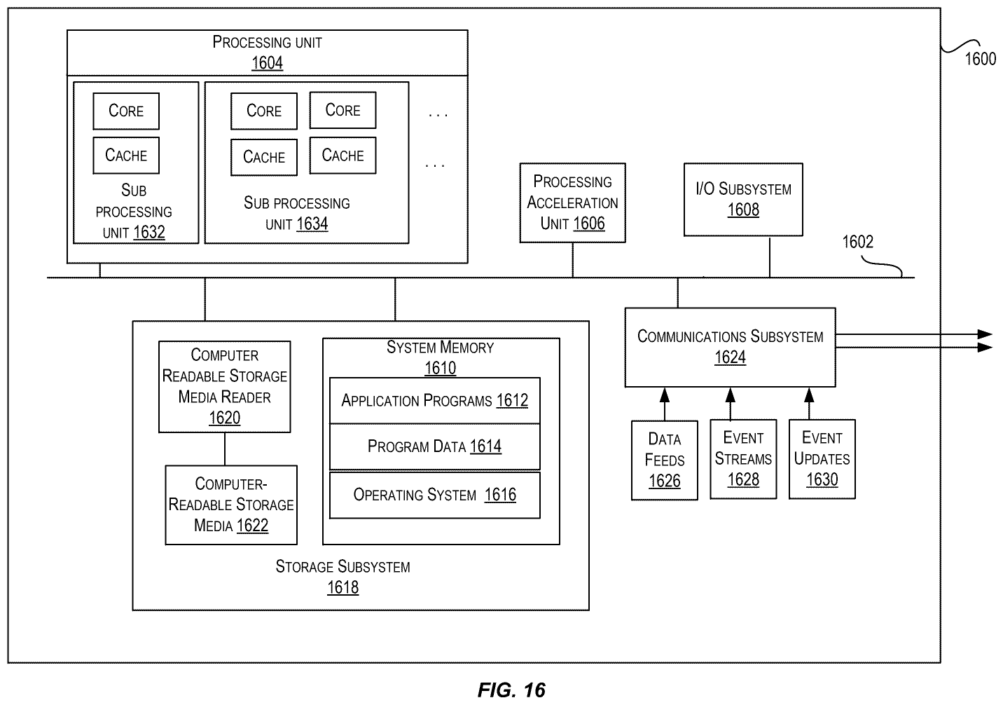

FIG. 16 illustrates an example computer system 1600, in which various embodiments may be implemented. The system 1600 may be used to implement any of the computer systems described above. As shown in the figure, computer system 1600 includes a processing unit 1604 that communicates with a number of peripheral subsystems via a bus subsystem 1602. These peripheral subsystems may include a processing acceleration unit 1606, an I/O subsystem 1608, a storage subsystem 1618 and a communications subsystem 1624. Storage subsystem 1618 includes tangible computer-readable storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative embodiments of the bus subsystem may utilize multiple buses. Bus subsystem 1602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1604, which can be implemented as one or more integrated circuits (e.g., a conventional microprocessor or microcontroller), controls the operation of computer system 1600. One or more processors may be included in processing unit 1604. These processors may include single core or multicore processors. In certain embodiments, processing unit 1604 may be implemented as one or more independent processing units 1632 and/or 1634 with single or multicore processors included in each processing unit. In other embodiments, processing unit 1604 may also be implemented as a quad-core processing unit formed by integrating two dual-core processors into a single chip.

In various embodiments, processing unit 1604 can execute a variety of programs in response to program code and can maintain multiple concurrently executing programs or processes. At any given time, some or all of the program code to be executed can be resident in processor(s) 1604 and/or in storage subsystem 1618. Through suitable programming, processor(s) 1604 can provide various functionalities described above. Computer system 1600 may additionally include a processing acceleration unit 1606, which can include a digital signal processor (DSP), a special-purpose processor, and/or the like.

I/O subsystem 1608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1600 may comprise a storage subsystem 1618 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1604 provide the functionality described above. Storage subsystem 1618 may also provide a repository for storing data used in accordance with the present disclosure.

As depicted in the example in FIG. 16, storage subsystem 1618 can include various components including a system memory 1610, computer-readable storage media 1622, and a computer readable storage media reader 1620. System memory 1610 may store program instructions that are loadable and executable by processing unit 1604. System memory 1610 may also store data that is used during the execution of the instructions and/or data that is generated during the execution of the program instructions. Various different kinds of programs may be loaded into system memory 1610 including but not limited to client applications, Web browsers, mid-tier applications, relational database management systems (RDBMS), virtual machines, containers, etc.

System memory 1610 may also store an operating system 1616. Examples of operating system 1616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1600 executes one or more virtual machines, the virtual machines along with their guest operating systems (GOSs) may be loaded into system memory 1610 and executed by one or more processors or cores of processing unit 1604.

System memory 1610 can come in different configurations depending upon the type of computer system 1600. For example, system memory 1610 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1610 may include a basic input/output system (BIOS) containing basic routines that help to transfer information between elements within computer system 1600, such as during start-up.

Computer-readable storage media 1622 may represent remote, local, fixed, and/or removable storage devices plus storage media for temporarily and/or more permanently containing, storing, computer-readable information for use by computer system 1600 including instructions executable by processing unit 1604 of computer system 1600.

Computer-readable storage media 1622 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1600.

Machine-readable instructions executable by one or more processors or cores of processing unit 1604 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to connect to one or more devices via the Internet. In some embodiments communications subsystem 1624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1624 can provide wired network connectivity (e.g., Ethernet) in addition to or instead of a wireless interface.

In some embodiments, communications subsystem 1624 may also receive input communication in the form of structured and/or unstructured data feeds 1626, event streams 1628, event updates 1630, and the like on behalf of one or more users who may use computer system 1600.

By way of example, communications subsystem 1624 may be configured to receive data feeds 1626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1624 may also be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1624 may also be configured to output the structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

It is noted that the system and methods described above may be implemented in a variety of ways, and such modifications are considered to be within the scope of the present disclosure. The various components of the systems shown herein may include, for example, memory, one or more processing units or one or more processors, and other hardware components. For example, memory may store program instructions that are loadable and executable on the processors, as well as data generated during the execution of these programs. Depending on the configuration, the memory may be volatile, such as random access memory (RAM), and/or non-volatile such as read-only memory (ROM), flash memory, removable storage and/or non-removable storage including, and not limited to, magnetic storage, optical disks, and/or tape storage. The disk drives and their associated non-transitory computer-readable media may provide non-volatile storage of computer-readable instructions, data structures, program services, and other data for use with the various embodiments. In some implementations, the memory may include multiple different types of memory, such as static random access memory (SRAM), dynamic random access memory (DRAM), ROM, etc.

In embodiments, the memory may include an operating system and one or more application programs or services for implementing the features disclosed herein. The system architecture may additionally include one or more service provider computers that may, in some examples, provide computing resources such as, but not limited to, client entities, low latency data storage, durable data storage, data access, management, virtualization, hosted computing environment or “cloud-based” solutions, etc. The service provider computers may implement or be an example of one or more incremental snapshot processes, block volume restore processes, site hosting, computer application development, and/or implementation platforms.

In some examples, the networks connecting the various components and supporting the various steps in the above described methods may include any one or a combination of many different types of networks, such as cable networks, the Internet, wireless networks, cellular networks, and other private and/or public networks. As a further example, various functions described above may be executed by one or more virtual machines implemented in a hosted computing environment, such as illustrated in FIG. 12. The hosted computing environment may include one or more rapidly provisioned and released computing resources, which computing resources may include computing, networking, and/or storage devices.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The figures and above description are illustrative and is not restrictive. In the above description, for the purposes of explanation, specific details are set forth in order to provide a thorough understanding of certain embodiments. However, it will be apparent that various embodiments may be practiced without these specific details. Many variations of the techniques described herein may become apparent to those skilled in the art upon review of the disclosure. The scope of the techniques can, therefore, be determined not with reference to the above description, but instead can be determined with reference to the pending claims along with their full scope or equivalents.

One or more features from any embodiment may be combined with one or more features of any other embodiment without departing from the scope of the techniques.

A recitation of “a,” “an,” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a computing system, first content in a first language;
performing, by the computing system, an inference of the first content for presence of a plurality of aspects, wherein performing the inference includes:
identifying one or more aspects within the first content,
annotating the first content in accordance with the identified one or more aspects, and
generating an annotated first content;
receiving, by the computing system, second content in a second language, wherein at least a portion of the second content includes a translation of the first content into the second language;
performing, by the computing system, the inference of the second content for presence of the plurality of aspects to generate an annotated second content; and
producing, by the computing system, a training set in the second language from the annotated second content,
wherein the training set is suitable for use, in the second language, in refining the inference in classifying portions of the second content into one of a plurality of polarities associated with the plurality of aspects.

2. The method of claim 1, further comprising, by the computing system, filtering the annotated second content by comparing the annotated second content with the annotated first content,
wherein producing the training set includes integrating the filtered annotated second content into the training set.

3. The method of claim 2, wherein filtering the annotated second content includes
comparing a first number of aspects identified in a portion of the first content with a second number of aspects identified in a corresponding portion of the second content, and
if the first number of aspects is not equal to the second number of aspects, then eliminating the corresponding portion of the second content from the training set.

4. The method of claim 2, wherein filtering the annotated second content includes
noting a first set of words used in a portion of the first content,
noting a second set of words used in a corresponding portion of the second content, and
if a first number of words in the first set of words do not correspond to a second number of words in the second set of words, then eliminating the corresponding portion of the second content from the training set.

5. The method of claim 2, wherein filtering the annotated second content further includes
noting a first set of aspects identified in a portion of the first content,
noting a second set of aspects identified in a corresponding portion of the second content, and
if the first set of aspects and the second set of aspects are not in agreement, then eliminating the corresponding portion of the second content from the training set.

6. The method of claim 2, wherein filtering the annotated second content further includes
noting a first set of words used in a portion of the first content,
noting a second set of words used in a corresponding portion of the second content,
generating an alignment score for the corresponding portion of the second content in accordance with alignment of the second set of words with the first set of words,
comparing the alignment score with a threshold alignment score, and
if the alignment score is below the threshold alignment score, eliminating the corresponding portion of the second content from the training set.

7. The method of claim 6, wherein the threshold alignment score is determined based on at least one of a manually configured parameter and a statistical analysis of alignment scores observed across different languages.

8. The method of claim 6, generating the alignment score includes using a dot product operation between embedded tokens in the portion of the first content and the portion of the second content.

9. The method of claim 1, wherein performing the inference includes using an inference model pre-trained on a gold data set including known annotated data in the first language.

10. The method of claim 1, wherein the first content is generated using a large language model.

11. The method of claim 10, wherein the second content is generated by a machine translation of the first content.

12. The method of claim 10, further comprising finetuning instructions provided to the large language model to produce the first content.

13. The method of claim 1, further comprising:
extracting a portion of the first content;
substituting words within the portion of the first content to flip sentiments associated with the plurality of polarities;
adding the portion of the first content, including the substituted words, into the first content to produce a modified first content;
translating the modified first content to produce a modified second content; and
repeating performing the inference, filtering, and producing the training set for the modified first content and the modified second content.

14. The method of claim 1, further comprising:
extracting a portion of the first content;
modifying words in the portion, other than the one or more aspects, by changing at least one of morphology, tense, pronoun, and phrasing;
adding the portion of the first content, including the substituted words, into the first content to produce a modified first content;
translating the modified first content to produce a modified second content; and
repeating performing the inference, filtering, and producing the training set for the modified first content and the modified second content.

15. The method of claim 14, wherein modifying words in the portion includes substituting at least one of the words in the portion with one of a synonym and an antonym.

16. The method of claim 1, further comprising:
extracting a portion of the training set;
modifying at least one of the plurality of polarities in the extracted portion; and
adding the modified portion into the training set to produce a modified training set.

17. A computing system, comprising:
one or more data processors; and
a storage medium configured to store instructions that, when executed on the one or more processors, cause the one or more data processors to perform operations comprising:
receiving, by the computing system, first content in a first language;
performing, by the computing system, an inference of the first content for presence of a plurality of aspects, wherein performing the inference includes:
identifying one or more aspects within the first content,
annotating the first content in accordance with the identified one or more aspects, and
generating an annotated first content;
receiving, by the computing system, second content in a second language, wherein at least a portion of the second content includes a translation of the first content into the second language;
performing, by the computing system, the inference of the second content for presence of the plurality of aspects to generate an annotated second content; and
producing, by the computing system, a training set in the second language from the annotated second content,
wherein the training set is suitable for use, in the second language, in refining the inference in classifying portions of the second content into one of a plurality of polarities associated with the plurality of aspects.

18. The computing system of claim 17, the operations further comprising
filtering, by the computing system, the annotated second content by comparing the annotated second content with the annotated first content,
wherein producing the training set includes integrating the filtered annotated second content into the training set.

19. The computing system of claim 18, wherein filtering the annotated second content includes
comparing a first number of aspects identified in a portion of the first content with a second number of aspects identified in a corresponding portion of the second content, and
if the first number of aspects is not equal to the second number of aspects, then eliminating the corresponding portion of the second content from the training set.

20. A non-transitory computer-readable medium storing a plurality of instructions executable by one or more processors of a computing system, wherein the plurality of instructions cause, when executed by the one or more processors of the computing system, the one or more processors to perform operations comprising:
receiving, by the computing system, first content in a first language;
performing, by the computing system, an inference of the first content for presence of a plurality of aspects, wherein performing the inference includes:
identifying one or more aspects within the first content,
annotating the first content in accordance with the identified one or more aspects, and
generating an annotated first content;
receiving, by the computing system, second content in a second language, wherein at least a portion of the second content includes a translation of the first content into the second language;
performing, by the computing system, the inference of the second content for presence of the plurality of aspects to generate an annotated second content; and
producing, by the computing system, a training set in the second language from the annotated second content,
wherein the training set is suitable for use, in the second language, in refining the inference in classifying portions of the second content into one of a plurality of polarities associated with the plurality of aspects.
